(19) United States
(12) Patent Application Publication
(10) Pub. No.: US 2026/0061560 A1
(43) Pub. Date: Mar. 5, 2026

(54) ABRASIVE AGGLOMERATES HAVING CUBIC BORON NITRIDE, ABRASIVE ARTICLE INCLUDING ABRASIVE AGGLOMERATES INCLUDING CUBIC BORON NITRIDE AND METHODS OF FORMING

(71) Applicants: SAINT-GOBAIN ABRASIVES, INC., Worcester, MA (US); SAINT-GOBAIN ABRASIFS, Conflans-Sainte-Honorine (FR)

(72) Inventors: Jianna WANG, Grafton, MA (US); Charles J. GASDASKA, Shrewsbury, MA (US)

(21) Appl. No.: 19/107,360

(22) PCT Filed: Aug. 31, 2023
(86) PCT No.: PCT/US2023/031701

§ 371 Date: Feb. 27, 2025

Related U.S. Application Data
(60) Provisional application No. 63/374,049, filed on Aug. 31, 2022.

(51) Int. Cl. B24D 3/18; C09K 3/14

(52) U.S. Cl. CPC B24D 3/18; C09K 3/1409

(57) ABSTRACT

Abrasive agglomerates can include cubic boron nitride particles and a vitrified binder material. An abrasive article can include the abrasive agglomerates and a vitrified bond material. The bond material can include zircon, crystalline zirconia, lithium-aluminum-silicate, or any combination thereof. In an embodiment, the bond material may include zircon of greater than 0.5 wt % and less than 7.25 wt % for a total weight of the bond material. In another embodiment, the abrasive article may include a permeability of at least 15 Darcy and a modulus of Rupture of at least 14 MPa.

### TECHNICAL FIELD

The present disclosure relates to abrasive agglomerates including cubic boron nitride, abrasive articles including the abrasive agglomerates, and methods of making the same.

Abrasive tools, such as abrasive wheels are typically used for cutting, abrading, and shaping of various materials, such as stone, metal, glass, plastics, among other materials. Abrasive tools are generally formed to have abrasive grains contained within a bond material. Various types of abrasive particles can be contained within the bond material, including for example, superabrasive grains (e.g., diamond or cubic boron nitride) or alumina abrasive grain. The bond material can include organic materials, such as a resin, or an inorganic material, such as a glass or vitrified material. The industry continues to demand abrasive wheels capable of improved performance.

### BRIEF DESCRIPTION OF THE DRAWINGS

Embodiments are illustrated by way of example and are not limited in the accompanying figures.

FIG. 1 includes a flowchart illustrating a process for forming abrasive agglomerates according to an embodiment.

FIG. 2 includes a microscopic image including abrasive agglomerates according to an embodiment.

FIG. 3 includes a flowchart illustrating a process for forming abrasive articles according to an embodiment.

FIG. 4 includes an SEM image including a portion of an abrasive article according to an embodiment.

FIG. 5A includes a graph illustrating wear of abrasive samples in a material removal operation.

FIG. 5B includes a graph illustrating G-ratio of abrasive samples.

FIG. 5C includes a plot of corner radius vs. cumulative material removal of abrasive samples.

FIG. 6A includes a plot of power vs. cumulative material removal of abrasive samples.

FIG. 6B includes a plot of specific power vs. material removal rates of abrasive samples.

FIG. 7A includes a graph illustrating 4-point flexure strength of abrasive samples.

FIG. 7B includes a graph illustrating gas permeability of the abrasive samples.

FIG. 8A includes a plot of surface roughness vs. cumulative material removal of abrasive samples.

FIG. 8B includes a plot of corner radius vs. cumulative material removal of additional abrasive samples.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE PREFERRED EMBODIMENT(S)

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including.” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the abrasive arts.

Embodiments relate to agglomerates including abrasive particles including cubic boron nitride and a binder material. In particular, the binder material may include vitrified material. In an embodiment, the abrasive agglomerates may have a higher weight content of abrasive particles than the binder material for a total weight of the abrasive agglomerates. The abrasive agglomerates can have improved properties including, for example, cutting ability, porosity, permeability, microstructure, crush strength, or any combination thereof. The abrasive agglomerates can be suitably incorporated into a variety of abrasive tools.

Further embodiments relate to abrasive articles including a bond material and the abrasive agglomerates. The bond material may include a vitrified material. The abrasive articles may have improved microstructures, properties, or any combination thereof. For example, the abrasive articles may have high permeability and improved mechanical properties, such as Modulus of Rupture, Modulus of Elasticity, flexural strength, hardness, or any combination thereof. The abrasive article may be suitable for a variety of material removal operations, such as cutting, grinding, drilling, or the like, or any combination thereof. The abrasive article may have improved performance comparing to conventional abrasive tools that are used in similar applications. For example, the abrasive article can operate at high material removal rates at a lower power draw. More particularly, the abrasive articles may operate at high material removal rates without overheating or causing burn marks on work pieces. In another example, the abrasive article may require less dressing frequency in material removal operations while operating at high material removal rates comparing to conventional abrasive tools.

In particular examples, the abrasive article of embodiments herein may be suited for grinding aerospace metal alloys with improved performance. Aerospace metal alloys can be extremely difficult to grind because of their highly susceptible to oxidation, especially at elevated temperatures such as those created during grinding. The oxidation reaction is highly exothermic thereby generating a substantial amount of heat which is additive with the normal heat of grinding experienced grinding any metal. To compound the problem, titanium-based metals generally have relatively low thermal conductivity as compared with the ferrous metals, which results in a greater concentration of heat at the grinding surface. Exemplary alloys may include titanium-containing metal and titanium-containing metal alloys, and more particularly, titanium-based metals and metal alloys, such as titanium aluminide, Ti-6Al-4V and the like. The abrasive article may also be suitable for material removal operations performed on certain other materials, such as a nickel-containing material, which can be for example, nickel-containing metals and nickel-containing metal alloys and particularly include nickel-based metals and metal alloys. In a non-limiting embodiment, the nickel-containing material can include INCONEL® alloy 617, INCONEL® alloy 625, INCONEL® alloy 625LCF®, INCONEL® alloy 706, INCONEL® alloy 718, INCONEL® alloy 718SPF™, INCONEL® alloy 725, INCONEL® alloy X-750, INCONEL® alloy MA754, INCONEL® alloy 783, INCONEL® alloy HX, NILO® alloy 42, NIMONIC® alloy 75, NIMONIC® alloy 80A, NIMONIC® alloy 86, NIMONIC® alloy 90, NIMONIC® alloy 105, NIMONIC® alloy 115, NIMONIC® alloy 901, NIMONIC® alloy PE16, NIMONIC® alloy PK33, NIMONIC® alloy 263, NILO® alloy 36, INCOLOY® alloy 903, INCOLOY® alloy 907, INCOLOY® alloy 909, INCOLOY® alloy A-286, UDIMET® alloy 188, UDIMET® alloy 520, UDIMET® alloy L-605, UDIMET® alloy 720, UDIMET® alloy D-979, UDIMET® alloy R41, Waspaloy, cast iron (e.g, grey cast iron, nodular cast iron, and chilled cast iron). In another non-limiting embodiment, such material can include an aluminum-containing material (e.g., aluminum alloys), stainless steel, nitrided metals, and hardened steel.

In an embodiment, the abrasive article may include a fixed abrasive article, and in particular examples, a bonded abrasive article. The abrasive article may include a bonded abrasive body in a shape including wheels, discs, hones, cones, cups, flanged shapes, cylinders, rings, or the like. In a particular embodiment, the abrasive article may include fixed abrasives that are configured for creepfeed grinding.

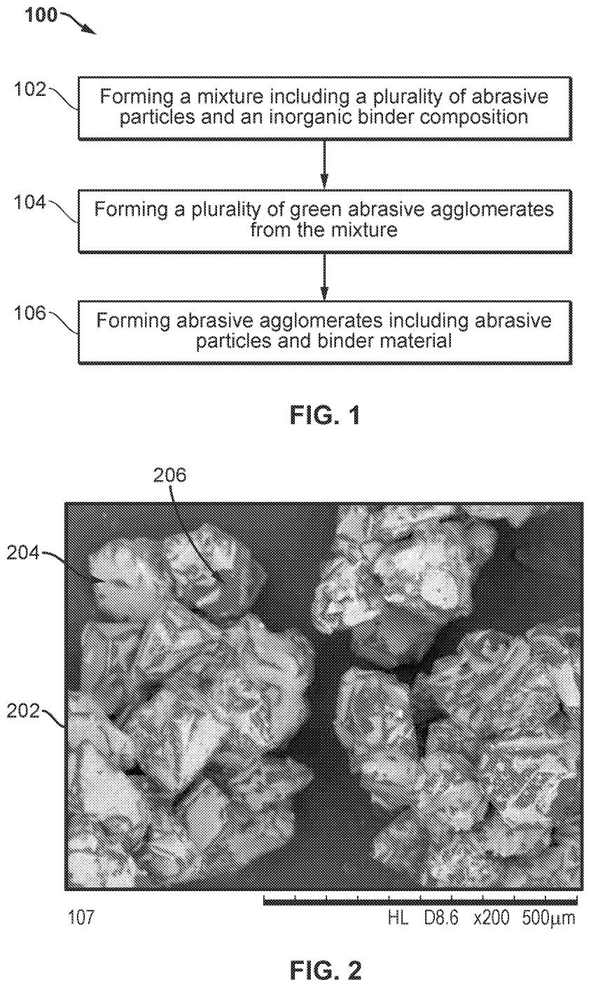

FIG. 1 includes an illustration of a process 100 for forming abrasive agglomerates. The process 100 may start at block 102 forming a mixture including abrasive particles and a binder composition. The abrasive particles can include superabrasive material, such as cubic boron nitride. In a particular embodiment, the abrasive particles may consist essentially of a superabrasive material including cubic boron nitride. In a more particular embodiment, the abrasive particles can consist essentially of cubic boron nitride particles.

The abrasive particles may include an average particle size (D₅₀). In an embodiment, the abrasive particles may include an average particle size of at least 0.1 microns, such as at least 1 micron, at least 5 microns, at least 10 microns, at least 20 microns, at least 30 microns, at least 40 microns, at least 50 microns, at least 75 microns, at least 90 microns, at least 105 microns, at least 130 microns, at least 150 microns, at least 165 microns, at least 180 microns, at least 200 microns, at least 225 microns, or even at least 240 microns. Still, in another non-limiting embodiment, the abrasive particles can have an average particle size of at most 5000 microns, such as at most 4000 microns, or even at most 3000 microns, at most 2000 microns, at most 1000 microns, at most 500 microns, at most 300 microns, or even at most 250 microns. It will be appreciated that the abrasive particles can have an average particle size within a range including any of the minimum and maximum values noted above. For example, the abrasive particles may include an average particle size in a range including at least 0.1 micron and at most 5000 microns, such as in a range including at least 70 and at most 300 microns, in a range including at least 95 microns to 225 microns, or in a range including at least 110 microns and at most 190 microns.

In an embodiment, the binder composition may include an inorganic material. In particular, the binder composition may consist essentially of an inorganic material. In an aspect, the binder composition may include a vitrified material. In another aspect, the binder composition can include a ceramic. An exemplary ceramic may include one or more metal oxides. In another aspect, the binder composition may include a powder material that may include a frit. In an example, the binder composition may include a glass composition that can include one or more oxides. Exemplary oxides may include one or more oxides including alkali metal element, alkaline earth element, transition metal element, rare earth element, or any combination thereof. Particular example of oxides can include silicon dioxide (silica) (SiO₂), boron trioxide (boria) (B₂O₃), zirconium dioxide (ZrO₂), aluminum oxide (alumina) (Al₂O₃), barium oxide (baria) (BaO), magnesium oxide (magnesia) (MgO), calcium oxide (calcia) (CaO), sodium oxide (Na₂O), potassium oxide (K₂O), lithium oxide (lithia) (Li₂O), or any combination thereof. In instances, the binder composition may include a trace amount or be essentially free of one or more metal oxide selected from manganese oxide (MnO₂), molybdenum trioxide (molybdite) (MoO₃), phosphorus pentoxide (P₂O₅), titanium dioxide (titania) (TiO₂), vanadium oxide (V₂O₅), cobalt oxide (CoO), copper (II) oxide (cupric oxide) (CuO), nickel oxide (NiO), strontium oxide (strontia) (SrO), zinc oxide (calamine) (ZnO), chromium oxide (chromia) (Cr₂O₃), yttrium oxide (yttria) (Y₂O₃), iron (III) oxide (Fe₂O₃), or combinations thereof.

In at least one embodiment, the binder composition may include a total content of at most 1 wt % of transition metal oxides, such as at most 0.7 wt %, at most 0.5 wt %, or at most 0.3 wt % for the total weight of the binder composition. In particular embodiment, the binder composition may be essentially free of transition metal oxide. For example, a total content of transition metal oxides may be at most 0.2 wt %, at most 0.1 wt %, or at most 0.05 wt % for the total weight of the binder material.

In another particular example, the binder composition may include one or more oxide including silica (SiO₂), alumina (Al₂O₃), boron oxide (B₂O₃), one or more alkali oxide including potassium oxide (K₂O), lithium oxide (Li₂O), sodium oxide (Na₂O), or any combination thereof, alkaline earth oxide including magnesium oxide (MgO), barium oxide (BaO), calcium oxide (CaO), or any combination thereof, zirconium oxide (ZrO₂). In a more particular example, the binder composition may include a ceramic-glass composition including silica (SiO₂), alumina (Al₂O₃), boron oxide (B₂O₃), potassium oxide (K₂O), lithium oxide (Li₂O), sodium oxide (Na₂O), magnesium oxide (MgO), barium oxide (BaO), calcium oxide (CaO), and zirconium oxide (ZrO₂).

According to an exemplary embodiment, the binder composition may be essentially free of strontium oxide (SrO), sodium oxide, or both. Moreover, in other instances, the binder composition may be essentially free of rare earth oxides, such as yttrium oxide (Y₂O₃). In yet another instance, the binder composition can be essentially free of a metal, and more particularly may be essentially free of aluminum metal. Moreover, the binder composition may be essentially free of other elements and compounds including for example, one or more or all of iron oxide (Fe₂O₃), chromium oxide (Cr₂O₃), manganese oxide (MnO₂), nickel oxide (NiO), zinc oxide (ZnO), and titanium dioxide (TiO₂). Additionally, the binder composition can be essentially free of a polymer, including for example, a resin material, a thermoplastic material, a thermoset material, or a combination thereof. A compound that is considered essentially free is reference to a content of at most 0.2 wt %, and may be at most 0.1 wt %, or at most 0.05 wt % for the total weight of the binder material. In an embodiment, the binder composition may include a glass-ceramic composition including oxides noted in embodiments herein.

In a further embodiment, the binder composition may have a particular glass transition temperature, sintering temperature, or combination thereof, that may facilitate improved formation and structure and/or properties of the abrasive agglomerates and abrasive article. In a particular embodiment, the binder composition may include a sintering temperature (Ts) in a range of 850° C. to 1100° C. In another particular embodiment, the binder composition may have a glass transition temperature (Tg) in a range of 850° C. to 1200° C.

In an embodiment, the mixture including the binder composition and the abrasive particles may also include one or more filler materials. The filler material can be distinct from the abrasive particles and may have a hardness less than a hardness of the abrasive particles. The filler material may provide improved mechanical properties and facilitate formation of the abrasive agglomerates according to the embodiments. In at least one embodiment, the filler material can include various materials, such as glass fibers, woven materials, non-woven materials, particles, minerals, oxides, alumina, carbide, nitrides, borides naturally occurring materials, and a combination thereof. In particular instances, the filler material can include a material such as wollastonite, mullite, steel, iron, copper, brass, bronze, tin, aluminum, kyanite, alusite, garnet, quartz, fluoride, mica, nepheline syenite, sulfates (e.g., barium sulfate), carbonates (e.g., calcium carbonate), cryolite, glass, glass fibers, titanates (e.g., potassium titanate fibers), rock wool, clay, sepiolite, an iron sulfide (e.g., Fe₂S₃, FeS₂, or a combination thereof), graphite, fine alundum powders, P15A, bubbled alumina, glass spheres, silver, alkali halides, and attapulgite.

Formation of the mixture can include forming a dry or wet mixture. It may be suitable to create a wet mixture to facilitate suitable dispersion of the abrasive particles within the binder composition. Moreover, it will be appreciated that the mixture can include other materials, including for example a filler, additives, temporary binders such as organic binders, and any other materials known in the art to facilitate formation of a mixture to create a green product prior to formation of a vitrified bonded abrasive. In at least one embodiment, the mixture is essentially free of a pore former. For example, the mixture may include an aqueous solution of polyethylene glycol or other organic temporary binders known in the art to facilitate mixing and/or shaping of the mixture. In further examples, mixing may be facilitated by using a mortar and pestle, an automated tumbler, acoustic mixer, centrifugal mixer, an automated grinder mixer, or the like, until uniform mixture is formed.

Referring to FIG. 1, after forming a mixture including abrasive particles and binder composition at step 102, the process can continue at step 104 to form a plurality of green abrasive agglomerates from the mixture. Green abrasive agglomerates may be further treated to form finally-formed abrasive agglomerates, which is described in details in subsequent paragraphs of this disclosure. In exemplary implementations, the mixture may be shaped into agglomerated particles using a shaping device having a desirable shape. In further examples, shaping the mixture to form a plurality of green abrasive agglomerates may be accomplished by any means suitable for shaping a wet mixture into granules, including shaping by screening, pressing, sieving, extruding, segmenting, casting, stamping, crushing, cutting, or a combination thereof. In particular, the wet mixture may be shaped into the green abrasive agglomerates by pushing, or otherwise moving, the wet mixture through a sieve or screen. In a particular example, the mixture may be pushed through sieves having desirable pore sizes to facilitate formation of green agglomerates having desirable particle sizes.

After forming green abrasive agglomerates, the process 100 may proceed to step 106 to form finally formed abrasive agglomerates including the abrasive particles and binder material. In an embodiment, thermal treatment may be applied to the green abrasive agglomerates to facilitate formation of a plurality of finally-formed abrasive agglomerates. In an exemplary implementation, an initial heat may be applied to the green abrasive agglomerates to remove binders in the mixture. For example, the green agglomerates may be heated at a temperature in a range from 400° C. to 700° C. or in a range from 520° C. to 670° C. to burn out binders. In another example, the initial heat may be applied in air. In a further example, the green agglomerates may be heated for at least 1 hour, at least 2 hours, at least 3 hours, at least 4 hours, or at least 5 hours. Additionally or alternatively, the green agglomerates may be heated for at most 8 hours, at most 7 hours, at most 6 hours, at most 5 hours, at most 4 hours, or at most 3 hours. Moreover, the initial heat may be applied for a time period including any of the minimum and maximum values noted herein. After reading this disclosure, a skilled artisan understands that one or more parameters of the initial heat may be determined based on the binders, the binder composition, other parameters of the initial heat, or any combination thereof. For example, a higher temperature may be utilized with a shorter heating time.

After performing the initial heat to remove binders, a second temperature may be applied to sinter the green agglomerates. In an embodiment, sintering may be performed at a particular temperature to facilitate improved formation and structure and/or properties of abrasive agglomerates and abrasive articles. In an example, the sintering temperature may be at least 850° C., such as at least 890° C., at least 930° C., at least 950° C., at least 975° C., at least 990° C., or at least 1050° C. In another example, the sintering temperature may be at most 1250° C., such as at most 1100° C., at most 1050° C., at most 1000° C., at most 990° C., at most 975° C., at most 950° C., or at most 925° C. In a further example, the sintering temperature may be in a range including any of the minimum and maximum values noted herein.

In a further embodiment, sintering may be performed in an inert atmosphere to facilitate improved formation and structure and/or properties of abrasive agglomerates and abrasive articles. In an example, sintering may be performed in N₂ atmosphere. In a further example, sintering may be conducted in a condition that includes less than 100 ppm of O₂.

In a further embodiment, sintering may be performed for a particular time period that may facilitate improved formation and structure and/or properties of abrasive agglomerates and abrasive articles. In an example, the sintering time may be at least 3 hours, at least 3.5 hours, at least 4 hours, at least 4.5 hours, or at least 5 hours, at least 5.5 hours, at least 6 hours, or at least 6.5 hours. Additionally or alternatively, sintering may be performed for at most 8 hours, at most 7.5 hours, at most 7 hours, at most 6.5 hours, at most 6 hours, at most 5.5 hours, at most 5 hours, at most 4.5 hours, at most 5 hours, or at most 3.5 hours. Moreover, sintering may be performed for a time period including any of the minimum and maximum values noted herein.

In embodiment, sintering may include a particular ramp rate to increase the temperature to the sintering temperature that may facilitate improved formation of the abrasive agglomerates. For example, the ramp rate may be at least 0.5° C. min⁻¹, at least 0.9° C. min⁻¹, at least 1.2° C. min⁻¹, at least 1.7° C. min⁻¹, at least 2° C. min⁻¹, at least 2.5° C. min⁻¹, or at least 2.7° C. min⁻¹, at least 2.9° C. min⁻¹, at least 3.2° C. min⁻¹, at least 3.5° C. min⁻¹, at least 4° C. min⁻¹, at least 4.5° C. min⁻¹, at least 5° C. min⁻¹, at least 6° C. min⁻¹, at least 7° C. min⁻¹, at least 7.5° C. min⁻¹, at least 8° C. min⁻¹, at least 8.5° C. min⁻¹, at least 9° C. min⁻¹, or at least 9.5° C. min⁻¹. In another example, the ramp rate may be at most 15° C. min⁻¹, at most 13° C. min⁻¹, at most 12° C. min⁻¹, at most 10° C. min⁻¹, or at most 9° C. min⁻¹, at most 7° C. min⁻¹, at most 5° C. min⁻¹, at most 4.6° C. min⁻¹, at most 4.3° C. min⁻¹, at most 3.8° C. min⁻¹, at most 3.5° C. min⁻¹, at most 3.3° C. min⁻¹, at most 3.1° C. min⁻¹, at most 2.9° C. min⁻¹, at most 2.5° C. min⁻¹, or at most 2.2° C. min⁻¹. Moreover, the ramp rate may be in a range including any of the minimum and maximum values noted herein.

In an embodiment, the process 100 may include cooling the heated abrasive agglomerates after sintering is performed. In a further embodiment, cooling may include a plurality of cooling temperatures, cooling rates, or a combination thereof. For example, cooling may include cooling from the sintering temperature to a first cooling temperature, cooling from the first cooling temperature to a second cooling temperature lower than the first cooling temperature, and optionally, cooling from the second cooling temperature to a third cooling temperature lower than the second cooling temperature. Cooling may further include cooling the abrasive agglomerates to room temperature. In further instances, the second or the third cooling temperature may be room temperature. In at least one embodiment, cooling may be applied so that the agglomerates are cooled to room temperature from the sintering temperature without applying an intermediate cooling temperature.

In an embodiment, the process 100 may include a particular cooling rate to facilitate temperature decreasing from the sintering temperature to the first cooling temperature. In an example, the first cooling rate may be at least 1.5° C. min⁻¹, at least 1.7° C. min⁻¹, at least 1.9° C. min⁻¹, at least 2.1° C. min⁻¹, at least 2.3° C. min⁻¹, at least 2.5° C. min⁻¹, at least 2.8° C. min⁻¹, at least 3° ° C. min⁻¹, at least 3.2° C. min⁻¹, at least 3.4° C. min⁻¹, at least 3.5° C. min⁻¹, or at least 3.7° C. min⁻¹. In another example, the first cooling rate may be at most 50° C. min⁻¹, at most 40° C. min⁻¹, at most 30° C. min⁻¹, at most 20° C. min⁻¹, at most 10° C. min⁻¹, at most 8° C. min⁻¹, at most 7° C. min⁻¹, at most 6° C. min⁻¹, or at most 5° C. min⁻¹. Moreover, the cooling rate may be in a range including any of the minimum and maximum values noted herein.

After cooling to room temperature, abrasive agglomerates may be finally formed. As used herein reference to an agglomerate is reference to a particle including smaller particles (e.g., abrasive particles) contained within a binder material that may be a substantially uniform and continuous three-dimensional phase of material extending throughout the volume of the agglomerate. FIG. 2 includes a microscopic image of finally-formed abrasive agglomerates. Abrasive agglomerates 202 include a binder material 204 and abrasive particles 206 bonded by the binder material 204.

In an embodiment, the abrasive agglomerates may comprise a particular content of the binder material that may facilitate improved structure, and properties and/or performance of the abrasive agglomerates and abrasive article. In an example, the abrasive agglomerates may include at least 1 wt % of the binder material for a total weight of the agglomerates, at least 2 wt %, at least 3 wt %, at least 5 wt %, at least 7 wt %, at least 9 wt %, at least 10 wt %, or at least 12 wt % for a total weight of the abrasive agglomerates. In another example, the abrasive agglomerates may comprise at most 20 wt % of the binder material for a total weight of the agglomerates, such as at most 18 wt %, at most 16 wt %, at most 14 wt %, at most 12 wt %, at most 10 wt %, at most 8 wt %, or at most 6 wt % for a total weight of the abrasive agglomerates. Moreover, the abrasive agglomerates may include a content of the binder material in a range including any of the minimum and maximum percentages noted herein.

In an embodiment, the abrasive agglomerates may comprise a particular content of abrasive particles that may facilitate improved structure, and properties and/or performance of the abrasive agglomerates and abrasive article. In an example, the abrasive agglomerates may include greater than 50 wt % of abrasive particles for a total weight of the abrasive agglomerates, such as at least 52 wt %, at least 56 wt %, at least 59 wt %, at least 62 wt %, at least 65 wt %, at least 68 wt %, at least 70 wt %, at least 73 wt %, at least 77 wt %, at least 80 wt %, at least 83 wt %, at least 86 wt %, at least 88 wt %, at least 90 wt %, at least 92 wt %, or at least 95 wt % for a total weight of the abrasive agglomerates. In another example, the abrasive agglomerates may comprise at most 99 wt % of abrasive particles, such as at most 96 wt %, at most 93 wt %, at most 90 wt %, at most 87 wt %, at most 82 wt %, at most 78 wt %, at most 73 wt %, at most 70 wt %, at most 65 wt %, at most 62 wt %, at most 59 wt %, at most 56 wt %, or at most 53 wt % of abrasive particles for at total weight of the abrasive agglomerates. Moreover, the abrasive agglomerates may include a content of the abrasive particles in a range including any of the minimum and maximum percentages noted herein.

In a further embodiment, the abrasive agglomerates may comprise agglomerated cubic boron nitride particles. In a particular embodiment, the abrasive agglomerates may consist essentially of agglomerated cubic boron nitride particles. In a further embodiment the abrasive agglomerates may comprise cubic boron nitride particles and the binder material, wherein the cubic boron nitride particles may be in any of the contents noted in embodiments herein.

In an embodiment, the binder material of the finally-formed abrasive agglomerates may include a vitrified material. In an aspect, the binder material may include a certain content of a crystalline phase, amorphous phase, or both. In a particular aspect, the binder material may include a higher content of an amorphous phase than crystalline phase.

In an embodiment, the binder material may include a particular content of an amorphous phase that may facilitate improved structure, properties and/or performance of the abrasive agglomerates and abrasive article. In an example, the amorphous phase may be in a content of greater than 50 wt % for a total weight of the binder material, such as at least 55 wt %, greater than 55 wt %, greater than 57 wt %, at least 60 wt %, at least 62 wt %, or at least 64 wt % for a total weight of the binder material. In another example, the binder material may include an amorphous phase of at most 75 wt % for a total weight of the binder material, at most 70 wt %, at most 65 wt %, at most 64 wt %, at most 63 wt %, or at most 60 wt % for a total weight of the binder material. Moreover, the binder material may include an amorphous phase in a content including any of the minimum and maximum percentages noted herein. In this disclosure, the contents of amorphous phase and crystalline phases can be determined by using X-ray diffraction and Reitveld analysis and using corundum as standard in the analysis.

In an embodiment, the binder material may include one or more crystalline phases. In a particular example, the binder material may include a plurality of crystalline phases. In another embodiment, the binder material may include a particular total content of crystalline phases that may facilitate improved structure, properties and/or performance of the abrasive agglomerates and abrasive article. In an example, the total content of crystalline phases may be less than 50 wt % for a total weight of the binder material, such as at most 45 wt % for a total weight of the binder material, at most 40 wt %, at most 39 wt %, at most 38 wt %, at most 37 wt %, at most 36 wt %, or at most 35 wt % for a total weight of the binder material. In a further example, the binder material may include a total content of crystalline phases of at least 20 wt %, at least 26 wt %, at least 30 wt %, at least 33 wt %, at least 35 wt %, or at least 38 wt % for a total weight of the binder material. Moreover, the binder material may include a total content of crystalline phases in a range including any of the minimum and maximum percentages noted herein. In further embodiment, crystalline phases may include a single crystal phase, a polycrystalline phase, or any combination thereof.

In an embodiment, the binder material may include a particular composition that may include one or more oxide including silica (SiO₂), alumina (Al₂O₃), boron oxide (B₂O₃), zirconium oxide (ZrO₂), one or more alkali oxide including potassium oxide (K₂O), lithium oxide (Li₂O), sodium oxide (Na₂O), or any combination thereof, alkaline earth oxide including magnesium oxide (MgO), barium oxide (BaO), calcium oxide (CaO), or any combination thereof, or any combination thereof. In a further embodiment, the oxides may be present in the amorphous phase, one or more crystalline phases, or any combination thereof. In still another embodiment, one or more oxides may be formed into complex oxides including a plurality of cations.

In an embodiment, the binder material may include crystalline phases including one or more of an oxide, silicate, or any combination thereof. In an aspect, the binder material may include one or more crystalline phases including zircon (ZrSiO₄), zirconia (ZrO₂), lithium-aluminum-silicate, or any combination thereof.

In an embodiment, the binder material may include a crystalline phase including zircon (ZrSiO₄). In a further embodiment, the binder material may include a particular content of the crystalline phase including zircon that may facilitate improved structure, properties and/or performance of the abrasive agglomerates. For example, the crystalline phase including zircon may be in a content of greater than 1 wt % for a total weight of crystalline phases of the binder material, such as at least 1.3 wt %, at least 1.5 wt %, at least 1.8 wt %, at least 2.1 wt %, at least 2.3 wt %, at least 2.5 wt %, at least 2.9 wt %, at least 3.3 wt %, at least 3.5 wt %, at least 3.8 wt %, at least 4.1 wt %, at least 4.3 wt %, at least 4.5 wt %, at least 4.9 wt %, at least 5.3 wt %, at least 5.5 wt %, at least 5.8 wt %, at least 6.1 wt %, at least 6.3 wt %, at least 6.5 wt %, at least 6.8 wt %, or at least 7.2 wt % for a total weight of crystalline phases of the binder material. In another example, the crystalline phase including zircon (ZrSiO₄) may be present in a content of less than 21 wt %, at most 20 wt %, at most 18 wt %, at most 16 wt %, at most 14 wt %, at most 12 wt %, at most 10.5 wt %, at most 9.5 wt %, at most 8 wt %, at most 6.5 wt %, or at most 5.8 wt % for a total weight of crystalline phases of the binder material. Moreover, the crystalline phase including zircon may be in a content including any of the minimum and maximum percentages noted herein.

In an embodiment, the binder material may include a particular content of zircon (ZrSiO₄) for a total weight of the binder material that may facilitate improved structure, properties and/or performance of the abrasive agglomerates. For example, zircon may be in a content of greater than 0.5 wt % for a total weight of the binder material, such as at least 0.7 wt %, at least 0.9 wt %, at least 1.2 wt %, at least 1.5 wt %, at least 1.8 wt %, at least 2.1 wt %, at least 2.3 wt %, at least 2.5 wt %, at least 2.9 wt %, at least 3.3 wt %, at least 3.5 wt %, at least 3.8 wt %, at least 4.1 wt %, at least 4.3 wt %, at least 4.5 wt %, at least 4.9 wt %, at least 5.3 wt %, at least 5.5 wt %, at least 5.8 wt %, at least 6.1 wt %, at least 6.3 wt %, at least 6.5 wt %, at least 6.8 wt %, or at least 7.2 wt % for a total weight of the binder material. In another example, zircon (ZrSiO₄) may be present in a content of less than 7.25 wt % for the total weight of the binder material, such as at most 7 wt %, at most 6.8 wt %, at most 6.6 wt %, at most 6.4 wt %, at most 6.2 wt %, at most 5.9 wt %, at most 5.8 wt %, at most 5.6 wt %, at most 5.4 wt %, at most 5.2 wt %, at most 4.9 wt %, at most 4.6 wt %, at most 4.4 wt %, at most 4.1 wt %, at most 3.9 wt %, at most 3.6 wt %, at most 3.3 wt %, at most 3 wt %, at most 2.7 wt %, or at most 2.5 wt % for a total weight of the binder material. Moreover, the binder material may include zircon in a content including any of the minimum and maximum percentages noted herein.

In a further embodiment, the binder material may comprise a crystalline phase including tetragonal zirconia (tZrO₂), a crystalline phase including monoclinic zirconia (mZrO₂), or any combination thereof.

In another embodiment, the binder material may include a content of a crystalline phase including tetragonal zircon for a total weight of crystalline phases. In another embodiment, the crystalline phase including tetragonal zircon may be in a particular content that may facilitate improved structure, properties and/or performance of the abrasive agglomerates. For example, the crystalline phase including tetragonal zirconia (tZrO₂) may be present in a content of at least 0.3 wt % for a total weight of crystalline phases of the binder material, at least 0.5 wt %, at least 0.7 wt %, at least 1 wt %, at least 1.3 wt %, at least 1.5 wt %, at least 1.7 wt %, at least 1.8 wt %, at least 2.1 wt %, at least 2.5 wt %, at least 2.8 wt %, at least 3.2 wt %, at least 3.5 wt %, at least 3.8 wt %, at least 4.1 wt %, at least 4.3 wt %, at least 4.6 wt %, at least 4.8 wt %, or at least 5.1 wt % for a total weight of crystalline phases of the binder material. In another example, the crystalline phase including tetragonal zirconia (tZrO₂) may be present in a content of at most 8.4 wt % for a total weight of crystalline phases of the binder material, at most 8.2 wt %, at most at most 8 wt %, at most 7.5 wt %, at most 7.2 wt %, at most 7 wt %, at most at most 6.8 wt %, at most 6.5 wt %, at most 6.2 wt %, at most 5.9 wt %, at most 5.7 wt %, at most 5.5 wt %, at most 5.2 wt %, at most 5 wt %, at most 4.9, at most 4.5 wt %, at most 4.2 wt %, or at most 4 wt % for a total weight of crystalline phases of the binder material. Moreover, the binder material may include the crystalline phase including tetragonal zirconia in a content including any of the minimum and maximum percentages noted herein.

In an embodiment, the binder material may comprise tetragonal ZrO₂ (tZrO₂) in a content of at least 0.1 wt % for a total weight of the binder material, such as at least 0.3 wt %, at least 0.5 wt %, at least 0.8 wt %, at least 1 wt %, at least 1.2 wt %, at least 1.3 wt %, at least 1.5 wt %, at least 1.6 wt %, at least 1.8 wt %, at least 2 wt %, at least 2.2 wt %, at least 2.5 wt %, at least 2.8 wt %, at least 3.1 wt %, or at least 3.3 wt % for a total weight of the binder material. Alternatively or additionally, the binder material may comprise tetragonal ZrO₂ (tZrO₂) in a content of at most 3.3 wt %, at most 3.2 wt %, at most 3 wt %, at most 2.9, at most 2.7 wt %, at most 2.5 wt %, at most 2.3 wt %, at most 2.1 wt %, at most 1.9 wt %, at most 1.8 wt %, or at most 1.6 wt % for a total weight of the binder material. Moreover, the binder material may include tetragonal zircon in a content including any of the minimum and maximum percentages noted herein. In a further embodiment, essentially all of tetragonal ZrO₂ (tZrO₂) may be present in a crystalline phase of the binder material.

In another embodiment, the binder material may include a particular content of a crystalline phase including monoclinic zircon that may facilitate improved structure, properties and/or performance of the abrasive agglomerates. For example, the crystalline phase including monoclinic zirconia (mZrO₂) may be present in a content of at least 0.1 wt % for a total weight of crystalline phases of the binder material, at least 0.5 wt %, at least 0.7 wt %, at least 1 wt %, at least 1.3 wt %, at least 1.5 wt %, at least 1.7 wt %, at least 1.8 wt %, at least 2.1 wt %, at least 2.5 wt %, at least 2.7 wt %, at least 2.9 wt %, at least 3.1 wt %, at least 3.3 wt %, at least 3.5 wt %, at least 3.7 wt %, at least 3.9 wt %, or at least 4 wt % for a total weight of crystalline phases of the binder material. In another example, the crystalline phase including monoclinic zirconia (mZrO₂) may be present in a content of at most 73 wt % for a total weight of crystalline phases of the binder material, at most 69 wt %, at most at most 62 wt %, at most 58 wt %, at most 52 wt %, at most 47 wt %, at most at most 40 wt %, at most 35 wt %, at most 30 wt %, at most 25 wt %, at most 21 wt %, at most 16 wt %, at most 11 wt %, at most 8 wt %, at most 6 wt %, at most 4 wt %, at most 3.7 wt %, or at most 3.2 wt % for a total weight of crystalline phases of the binder material. Moreover, the binder material may include the crystalline phase including monoclinic zirconia in a content including any of the minimum and maximum percentages noted herein. In a further embodiment, essentially all of monoclinic ZrO₂ (mZrO₂) may be present in a crystalline phase of the binder material.

In another embodiment, the binder material may comprise monoclinic zirconia (mZrO₂) in a content of at least 0.1 wt % for at total weight of the binder material, such as at least 0.3 wt %, at least 0.5 wt %, at least 9.8 wt %, at least 1 wt %, at least 1.3 wt %, at least 1.5 wt %, at least 1.7 wt %, at least 1.8 wt %, or at least 2 wt % for at total weight of the binder material. Alternatively or additionally, the binder material may comprise monoclinic zirconia (mZrO₂) in a content of at most 3 wt % for a total weight of the binder material, at most 2.5 wt %, at most 2.2 wt %, at most 2 wt %, at most 1.8 wt %, at most 1.6, at most 1.5 wt %, at most 1.3 wt %, or at most 1.1 wt % for a total weight of the binder material. Moreover, the binder material may include monoclinic zirconia in a content including any of the minimum and maximum percentages noted herein.

In another embodiment, binder material may comprise a particular ratio C_{ZOT}/C_{ZOM} of a content of tetragonal ZrO₂ (tZrO₂), C_{ZOT}, to a content of monoclinic ZrO₂ (mZrO₂), C_{ZOM}, that may facilitate improved structure, properties and/or performance of the abrasive agglomerates, wherein the content of tetragonal ZrO₂ (tZrO₂), C_{ZOT}, is relative to a total crystalline phase weight content of the binder material, and the content of monoclinic ZrO₂ (mZrO2) C_{ZOM} is relative to the total crystalline phase weight content of the binder material. For example, the ratio C_{ZOT}/C_{ZOM} may be at least 0.003, at least 0.03, at least 0.3, at least 0.7, at least 1, at least 1.1, at least 1.2, at least 1.4, at least 1.6, at least 1.8, at least 2, or at least 2.1. In another example, the ratio C_{ZOT}/C_{ZOM} may be less than 2.1, at most 2, at most 1.8, at most 1.6, at most 1.4, at most 1.3, at most 1.2, or at most 1. Moreover, the binder material may include the ratio C_{ZOT}/C_{ZOM} in a range including any of the minimum and maximum values noted herein.

In an embodiment, the binder material may comprise lithium-aluminum-silicate. In an example, the binder material may include a crystalline phase including lithium-aluminum-silicate. In a further example, the binder material may include phases of crystalline lithium-aluminum-silicates. In a further embodiment, the binder material may comprise a solid solution of Li₂O—Al₂O₃-nSiO₂, wherein n may include 2, 3, 4, 5, 6, 7, 8, 9, or any combination thereof. In particular embodiments, the binder material may comprise one or more crystalline phases including a solid solution of Li₂O—Al₂O₃-nSiO₂, wherein n may include 2, 3, 4, 5, 6, 7, 8, 9, or any combination thereof. In a particular embodiment, the binder material may include a crystalline phase including a solid solution of Li₂O—Al₂O₃-nSiO₂, wherein n may be selected from the group consisting of 2, 3, 5, 6, 7, 8 and 9. In a particular example, n may be greater than 4. In a more particular example, n may include 6. In another particular example, n may be at least 6. In an example, the solid solution of Li₂O—Al₂O₃-nSiO₂ may include a crystalline phase including LiAlSi₃O₈. In another example, the solid solution of Li₂O—Al₂O₃-nSiO₂ may include a first crystalline phase including LiAlSi₃O₈, a second crystalline phase including Li_{0.25}Al_{0.25}Si_{0.75}O₂, or a combination thereof.

In an embodiment, the binder material may comprise a particular content of LiAlSi₃O₈ that may facilitate improved structure, properties and/or performance of the abrasive agglomerates. For example, LiAlSi₃O₈ may be in a content of greater than 13 wt % for a total weight of the binder material, at least 14 wt %, at least 17 wt %, at least 20 wt %, at least 22 wt %, at least 25 wt %, at least 28 wt %, or at least 30 wt % for a total weight of the binder material. In another example, LiAlSi₃O₈ may be in a content of at most 45 wt % for a total weight of the binder material, such as at most 40 wt %, at most 38 wt %, at most 36 wt %, at most 32 wt %, at most 29 wt %, at most 27 wt %, at most 25 wt %, at most 22 wt %, at most 20 wt %, at most 16 wt %, or at most 14 wt % for a total weight of the binder material. Moreover, the binder material may include a content of LiAlSi₃O₈ in a range including any of the minimum and maximum percentages noted herein. In a further embodiment, essentially all of LiAlSi₃O₈ may be present in a crystalline phase of the binder material.

In another embodiment, the binder material may include a particular content of the crystalline phase including LiAlSi₃O₈ that may facilitate improved structure, properties and/or performance of the abrasive agglomerates. For example, the crystalline phase including LiAlSi₃O₈ may be in a content of at least 30 wt % for a total weight of crystalline phases of the binder material, at least 35 wt %, at least 38 wt %, at least 42 wt %, at least 46 wt %, at least 50 wt %, at least 55 wt %, at least 60 wt %, at least 65 wt %, or at least 70 wt %, at least 73 wt %, at least 76 wt %, at least 80 wt %, or at least 82 wt % for a total weight of crystalline phases of the binder material. In another example, the crystalline phase including LiAlSi₃O₈ may be in a content of at most 90 wt % for a total weight of crystalline phases of the binder material, at most 87 wt %, at most 84 wt %, at most 81 wt %, at most 77 wt %, at most 74 wt %, at most 71 wt %, at most 65 wt %, at most 60 wt %, at most 55 wt %, at most 50 wt %, at most 45 wt %, at most 41 wt %, or at most 35 wt % for the total weight of crystalline phases of the binder material. Moreover, the binder material may include the crystalline phase including LiAlSi₃O₈ in a content including any of the minimum and maximum percentages noted herein.

In an embodiment, the binder material may comprise a particular content of Li_{0.25}Al_{0.25}Si_{0.75}O₂ that may facilitate improved structure, properties and/or performance of the abrasive agglomerates. For example, Li_{0.25}Al_{0.25}Si_{0.75}O₂ may be in a content of at least 0.4 wt % for a total weight of the binder material, at least 1 wt %, at least 1.3 wt %, at least 1.5 wt %, at least 1.7 wt %, at least 1.8 wt %, at least 2 wt %, at least 2.3 wt %, at least 2.5 wt %, at least 2.7 wt %, at least 3 wt %, at least 3.2 wt %, at least 3.4 wt %, at least 3.6 wt %, at least 3.9 wt %, at least 4.4 wt %, at least 4.9 wt %, at least 5.1 wt %, at least 5.4 wt %, at least 6 wt %, at least 8 wt %, at least 11 wt %, at least 14 wt %, at least 17 wt %, or at least 20 wt % for a total weight of the binder material. In another example, Li_{0.25}Al_{0.25}Si_{0.75}O_{2, 8} may be in a content of at most 20 wt %, at most 16 wt %, at most 13 wt %, at most 10 wt %, at most 7 wt %, at most 5.5 wt %, at most 5.1 wt %, at most 4.5 wt %, at most 3.5 wt %, at most 3 wt % at most 2 wt %, or at most 1.5 wt % for the total weight of the binder material. Moreover, the binder material may include a content of Li_{0.25}Al_{0.25}Si_{0.75}O₂ in a range including any of the minimum and maximum percentages noted herein. In a further embodiment, essentially all of Li_{0.25}Al_{0.25}Si_{0.75}O₂ may be present in a crystalline phase of the binder material.

In another embodiment, the binder material may include a particular content of a crystalline phase including Li_{0.25}Al_{0.25}Si_{0.75}O₂ that may facilitate improved structure, properties and/or performance of the abrasive agglomerates. For example, the crystalline phase including Li_{0.25}Al_{0.25}Si_{0.75}O₂ may be in a content of at least 1.2 wt % for the total weight of crystalline phases of the binder material, at least 2 wt %, at least 3 wt %, at least 5 wt %, at least 8 wt %, at least 10 wt %, at least 13 wt %, at least 16 wt %, at least 19 wt %, at least 22 wt %, at least 25 wt %, at least 30 wt %, at least 35 wt %, at least 40 wt %, at least 45 wt %, or at least 50 wt % for a total weight of crystalline phases of the binder material. In another example, the crystalline phase including Li_{0.25}Al_{0.25}Si_{0.75}O₂ may be in a content of at most 51 wt % for a total weight of crystalline phases, at most 47 wt %, at most 42 wt %, at most 39 at %, at most 34 wt %, at most 31 wt %, at most 28 wt %, at most 24 wt %, at most 21 wt %, at most 18 wt %, at most 15 wt %, at most 12 wt %, at most 10 wt %, at most 8 wt %, at most 5 wt %, or at most 2 wt % for a total weight of crystalline phases of the binder material. Moreover, the binder material may include a crystalline phase including Li_{0.25}Al_{0.25}Si_{0.75}O₂ in a content including any of the minimum and maximum percentages noted herein.

In an embodiment, the binder material may comprise a particular ratio C_{SI1}/C_{SI2} of a first content of LiAlSi₃O₈, C_{SI1}, to a second content of Li_{0.25}Al_{0.25}Si_{0.75}O₂, C_{SI2}, that may facilitate improved structure, properties and/or performance of the abrasive agglomerates, wherein the first content of LiAlSi₃O₈, C_{SI1}, is relative to a total weight content of crystalline phases of the binder material, and the second content of Li_{0.25}Al_{0.25}Si_{0.75}O₂, C_{SI2}, is relative to a total weight content of crystalline phase of the binder material. In an example, the ratio C_{SI1}/C_{SI2} may be greater than 0.65, at least 0.8, at least 1, at least 1.2, at least 1.5, at least 2, at least 2.5, at least 3, at least 3.5, at least 4, at least 4.5, at least 5, at least 5.5, at least 7, at least 9, at least 12, at least 15, at least 20, at least 30, at least 40, at least 50, at least 60, or at least 70. In another example, the ratio C_{SI1}/C_{SI2} is at most 90, at most 86, at most 84, at most 80, at most 75, at most 70, at most 65, at most 60, at most 55, at most 50, at most 45, at most 40, at most 35, at most 30, at most 20, at most 15, at most 10, at most 8, at most 5, or at most 3. Moreover, the binder material may include the C_{SI1}/C_{SI2} in a range including any of the minimum and maximum percentages noted herein.

In an embodiment, the binder material may be essentially free of mullite (Al₂(Al_{2.8}Si_{1.2})O_{9.6} or Al₆Si₂O₁₃), anorthite (Na_{0.4}Ca_{0.6}Al_{1.6}Si_{2.4}O₈), quartz (SiO₂), or any combination thereof. In another embodiment, the binder material may include silica, wherein essentially all of silica may be present in the amorphous phase of the binder material.

In an embodiment, the binder material may include an amorphous phase including a silicate. In another embodiment, the binder material may include a silicate glassy phase including one or more or all of the elements selected from Si, O, Al, Ba, Mg. Li, Ba, and K. In a further embodiment, the binder material may include Zr in the crystalline phase, amorphous phase, or both. In a particular embodiment, the majority or essentially all of Zr may be present in the crystalline phase. In an embodiment, the binder material may be essentially free of mullite (Al₂(Al_{2.8}Si_{1.2})O_{9.6} or Al₆Si₂O₁₃), anorthite (Na_{0.4}Ca_{0.6}Al_{1.6}Si_{2.4}O₈), quartz (SiO₂), crystalline LiAlSi₂O₆(Li₂O—Al₂O₃-nSiO₂ n=4), or any combination thereof. In a particular embodiment, the binder material may be essentially free of quartz (SiO₂). In another particular embodiment, the binder material may be essentially free of mullite (Al₂(Al_{2.8}Si_{1.2})O_{9.6} or Al₆Si₂O₁₃ or both). In a further particular embodiment, the binder material may be essentially free of anorthite (Na_{0.4}Ca_{0.6}Al_{1.6}Si_{2.4}O₈). In still another particular embodiment, the binder material may be essentially free of crystalline LiAlSi₂O₆ (Li₂O—Al₂O₃-nSiO₂ n=4).

In an embodiment, the abrasive agglomerates can include a particular average size (D50), a particular particle size distribution including D10, D50, or D90, or any combination thereof. For example, the abrasive agglomerates may include an average particle size of at least 2 microns, such as at least 5 microns, at least 10 microns, at least 20 microns, at least 50 microns, at least 75 microns, at least 90 microns, at least 100 microns, at least 125 microns, at least 140 microns, or at least 150 microns. In another example, the abrasive agglomerates can have an average particle size of at most 10,000 microns, such as at most 7500 microns, at most 5000 microns, at most 4000 microns, at most 2000 microns, at most 1800 microns, at most 1500 microns, at most 1200 microns, at most 1000 microns, at most 900 microns, at most 800 microns, at most 700 microns, or at most 600 microns. Moreover, the average size of the abrasive agglomerates can be within a range including any of the minimum and maximum values noted herein. In a particular example, the average particle size of the abrasive agglomerates can be in a range of at least 2 microns to at most 4000 microns.

The abrasive agglomerates can have a certain crush strength (represented by a crush %). In an embodiment, the abrasive agglomerates have a crush % value of at most 90%, such as at most 85%, at most 80%, at most 75%, at most 70%, at most 65%, at most 60%, at most 55%, at most 50%, at most 45%, at most 40%, or not even greater than 35%, wherein the crush % is measured at a load of 5 MPa. The crush strength can be measured at a particular sieve mesh size, such as US standard mesh (−35/+45), or (−40/+60), 40/80, 50/100, or 60/120, or the like.

In an embodiment, the abrasive agglomerates may have certain beneficial and characteristic properties. For example, the abrasive agglomerates can have a beneficial loose packed density in a particular range. In an embodiment, the abrasive aggregates have a loose packed density in a range of at least 0.5 g/cm³ to at most 3.5 g/cm³. In a specific embodiment, the abrasive aggregates have a loose packed density in a range of at least 2.75 g/cm³ to at most 3.0 g/cm³.

In an embodiment, the abrasive agglomerates can have a particular porosity that may facilitate improved properties and performance of the abrasive agglomerates and abrasive article. In an embodiment, the abrasive aggregates may have a porosity in a range of 5% to 85% as measured by mercury porosimetry.

Finally-formed abrasive agglomerates can be used as loose abrasives (e.g., in an abrasive slurry or as blast media) or incorporated into fixed abrasives. Fixed abrasives may include bonded abrasives, coated abrasives, nonwoven abrasives, engineered abrasives (also called structured abrasives), or combinations thereof. In particular embodiments, finally-formed abrasive agglomerates can be incorporated into bonded abrasives, such as grinding wheels, cutting wheels, or the like, or any combination thereof, nonwoven abrasive wheels, coated abrasive discs, coated abrasive belts, coated abrasive sheets, coated abrasive films, or a combination thereof.

In an embodiment, the amount of abrasive particles comprising the abrasive agglomerates can be at least 10 wt %, such as at least 15 wt %, at least 20 wt %, at least 25 wt %, at least 30 wt %, at least 40 wt %, or at least 45 wt %. In another embodiment, the amount of abrasive particles comprising the abrasive aggregate can be at most 99 wt %, such as at most 95 wt %, at most 90 wt %, at most 85 wt %, at most 80 wt %, at most 75 wt %, at most 70 wt %, or at most 65 wt %. The amount of abrasive particles can be within a range comprising any pair of the previous upper and lower limits. In a particular embodiment, the amount of abrasive particles can be in a range of at least 10 wt % to at most 99 wt %, such as 15 wt % to 95 wt %, or 20 wt % to 90 wt %. In a specific embodiment, the amount of abrasive particles can be 15 wt % to 30 wt %, 45 wt % to 55 wt %, 60 wt % to 70 wt %, or 85 wt % to 90 wt %.

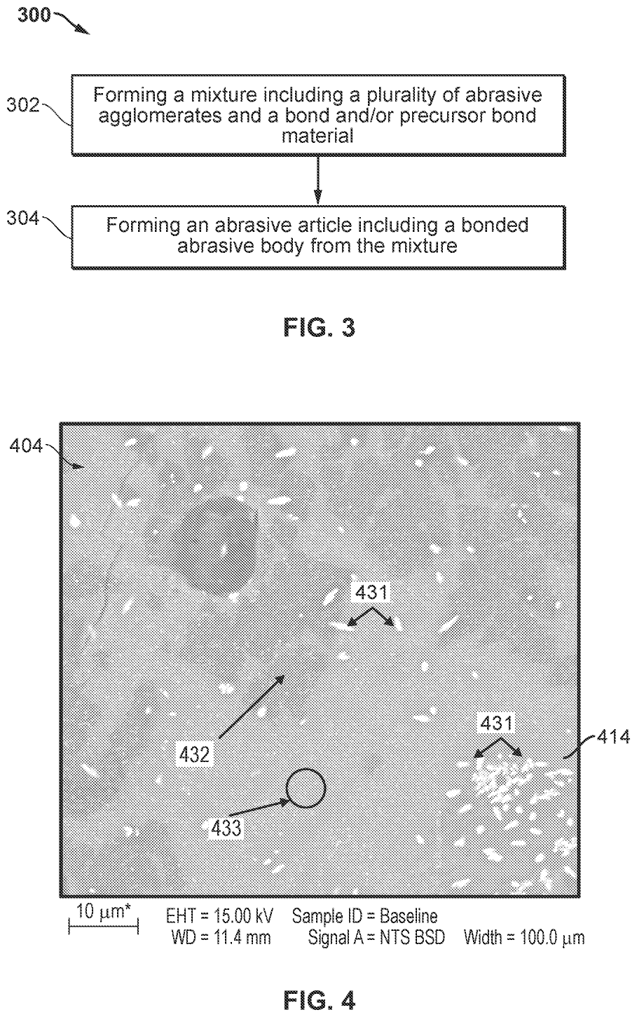

Referring again to FIG. 3, a process 300 is illustrated including at step 302, forming a mixture including the abrasive agglomerates and a bond and/or precursor bond material. The bond material may also be referred to as a precursor bond material, which can be in the form of a powder material until it is heat treated and forms the finally-formed bond material of the abrasive article. In an embodiment, the bond and/or precursor bond material may have a composition that may include any or all of the features discussed in embodiments herein in relation to the binder composition. In a further embodiment, the bond and/or precursor bond material may be substantially the same as or distinct from the binder composition. In a particular embodiment, the bond and/or precursor bond material can include a composition that is essentially the same as the binder composition described in embodiments herein.

The mixture including the abrasive agglomerates and bond and/or precursor bond material may be a dry or wet mixture. The mixture may include other materials, including for example a filler, additives, temporary binders such as organic binders, or any combination thereof. A mixing apparatus, such as one or more of the previously discussed, may be used to facilitate formation of a uniform mixture.

In an embodiment, the mixture may include a filler material. In an example, the filler material can include various materials, such as fibers, woven materials, non-woven materials, particles, minerals, nuts, shells, oxides, alumina, carbide, nitrides, borides, organic materials, polymeric materials, naturally occurring materials, and a combination thereof. In particular instances, the filler material can include a material such as wollastonite, mullite, steel, iron, copper, brass, bronze, tin, aluminum, kyanite, alusite, garnet, quartz, fluoride, mica, nepheline syenite, sulfates (e.g., barium sulfate), carbonates (e.g., calcium carbonate), cryolite, glass, glass fibers, titanates (e.g., potassium titanate fibers), rock wool, clay, sepiolite, an iron sulfide (e.g., Fe₂S₃, FeS₂, or a combination thereof), graphite, fine alundum powders, P15A, bubbled alumina, glass spheres, silver, alkali halides, and attapulgite.

In an embodiment, the mixture may include a pore former. An exemplary pore former may include a ceramic pore former, an organic pore former, or any combination thereof. In a further example, the pore former may be in a content of at least 2 wt %, at least 5 wt %, at least 8 wt %, or at least 10 wt % for the total weight of the mixture. In a further instance, the mixture may include at most 25 wt % of pore former for the total weight of the mixture, such as at most 20 wt %, at most 18 wt %, at most 15 wt %, or at most 12 wt % for the total weight of the mixture. Moreover, the mixture may include a content of pore former in a range including any of the minimum and maximum percentages noted herein. In a further example, the pore former may not be present in the finally-formed bonded abrasive body. In at least one embodiment, the mixture can be essentially free of a pore former.

Referring to FIG. 3, after forming a mixture including abrasive agglomerates and bond and/or precursor bond material at step 302, the process 300 can continue at step 304 to form an abrasive article including a finally-formed abrasive body, such as a bonded abrasive body, from the mixture. In an embodiment, forming the finally-formed abrasive body may include forming a green abrasive body from the mixture. Green abrasive body may be further treated to form finally-formed bonded abrasive body, which is described in details in subsequent paragraphs of this disclosure.

In an aspect, forming the green abrasive body may include shaping the mixture into a desirable shape. In an example, shaping may include pressing, molding, casting, cutting, printing, curing, depositing, drying, heating, cooling, or any combination thereof. In a particular example, a shaping device, such as a mold, having the desired shape may be used for forming the green body from the mixture.

After forming the green abrasive body, the process may continue to form the finally-formed abrasive body by treating the green body. In certain instances, the process of forming the green body and the process for forming the finally-formed abrasive body can be combined, such that the mixture is converted directly to the finally-formed abrasive body. Suitable processes for forming the finally-formed abrasive body can include pressing, molding, casting, cutting, printing, curing, depositing, drying, heating, cooling, or any combination thereof.

In an embodiment, thermal treatment may be applied to the green abrasive body or the mixture to facilitate formation of a finally-formed abrasive body. In an exemplary implementation, an initial heat may be applied to the green body or the mixture to remove binders in the mixture. For example, the green body may be heated at a temperature in a range from 500° C. to 700° C. or in a range from 550° C. to 670° C. to burn out binders. In another example, the initial heat may be applied in air. In a further example, the green body or mixture may be heated for at least 1 hour, at least 2 hours, at least 3 hours, at least 4 hours, or at least 5 hours. Additionally or alternatively, the green body or the mixture may be heated for at most 8 hours, at most 7 hours, at most 6 hours, at most 5 hours, at most 4 hours, or at most 3 hours. Moreover, the initial heat may be applied for a time period including any of the minimum and maximum values noted herein. After reading this disclosure, a skilled artisan understands that one or more parameters of the initial heat may be determined based on the binders, the composition of the bond and/or precursor bond material, other parameters of the initial heat, or any combination thereof. For example, a higher temperature may be utilized with a shorter heating time.

After performing the initial heat to remove binders, a second temperature may be applied to sinter the green body or the mixture. In an embodiment, sintering may be performed at a particular temperature to facilitate improved formation and structure and/or properties of abrasive articles. In an example, the sintering temperature may be at least 850° C., such as at least 890° C., at least 930° C., at least 950° C., at least 975° C., at least 990° C., or at least 1050° C. In another example, the sintering temperature may be at most 1250° C., such as at most 1100° C., at most 1050° C., at most 1000° C., at most 990° C., at most 975° C., at most 950° C., or at most 925° C. In a further example, the sintering temperature may be in a range including any of the minimum and maximum values noted herein. In a particular embodiment, the sintering temperature for forming the abrasive agglomerates may be essentially the same as the sintering temperature for forming the abrasive body.

In a further embodiment, sintering may be performed in certain atmosphere to facilitate improved formation and structure and/or properties of abrasive article. In an example, sintering may be performed in non-oxidizing atmospheres that can include one or more noble gas species and/or nitrogen. In a particular example, N₂ atmosphere may be utilized. In a further example, sintering may be conducted in a condition that includes less than 100 ppm of O₂.

In a further embodiment, sintering may be performed for a particular time period that may facilitate improved formation and structure and/or properties of abrasive article. In an example, the sintering time may be at least 3 hours, at least 3.5 hours, at least 4 hours, at least 4.5 hours, or at least 5 hours, at least 5.5 hours, at least 6 hours, or at least 6.5 hours. Additionally or alternatively, sintering may be performed for at most 8 hours, at most 7.5 hours, at most 7 hours, at most 6.5 hours, at most 6 hours, at most 5.5 hours, at most 5 hours, at most 4.5 hours, at most 5 hours, or at most 3.5 hours. Moreover, sintering may be performed for a time period including any of the minimum and maximum values noted herein.

In a particular embodiment, sintering may include pre-heating the green abrasive body or mixture and then heating at the sintering temperature. In an exemplary implementation, the green body or mixture may be heated to a pre-heating temperature that may be lower than the sintering temperature. In certain instances, the green body or mixture may be allowed to dwell for a period of time. In an example, pre-heating may be conducted at a temperature of at least 430° C., at least 470° C., at least 500° C., at least 530° C., at least 550° C., at least 580° C., or at least 600° C. In another example, pre-heating may be conducted at a temperature of at most 650° C., at most 620° C., at most 600° C., at most 570° C., at most 550° C., or at most 510° C. Moreover, pre-heating may be conducted at a temperature in a range including any of the minimum and maximum values noted herein.

In another example, pre-heating may be conducted for at least 2 hours, at least 3 hours, at least 4 hours, or at least 5 hours. Additionally or alternatively, pre-heating may be performed for at most 7 hours, at most 6 hours, at most 5 hours, at most 4 hours, or at most 3 hours. Moreover, pre-heating may be applied for a time period including any of the minimum and maximum values noted herein.

In embodiment, sintering may include a particular ramp rate to increase the temperature from room temperature (i.e., 20-28° C.) to the pre-heating temperature that may facilitate improved formation of the abrasive agglomerates. For example, the ramp rate may be at least 5° C. min⁻¹, at least 6° C. min⁻¹, at least 7° C. min⁻¹, at least 7.5° C. min⁻¹, at least 8° C. min⁻¹, at least 8.5° C. min⁻¹, at least 9° C. min⁻¹, or at least 9.5° C. min⁻¹. In another example, the ramp rate may be at most 15° C. min⁻¹, at most 13° C. min⁻¹, at most 12° C. min⁻¹, at most 10° C. min⁻¹, or at most 9° C. min⁻¹. Moreover, the ramp rate may be in a range including any of the minimum and maximum values noted herein.

In an embodiment, sintering may include a particular ramp rate to increase the temperature from the pre-heating temperature to the sintering temperature that may facilitate improved formation of the abrasive article. For example, the ramp rate may be at least 0.5° C. min⁻¹, at least 0.7° C. min⁻¹, at least 0.9° C. min⁻¹, at least 1° C. min⁻¹, at least 1.2° C. min⁻¹, at least 1.5° C. min⁻¹, at least 1.7° C. min⁻¹, at least 1.8° C. min⁻¹, at least 2° C. min⁻¹, at least 2.2° C. min⁻¹, at least 2.3° C. min⁻¹, at least 2.5° C. min⁻¹, or at least 2.7° C. min⁻¹. In another example, the ramp rate may be at most 10° C. min⁻¹, at most 8° C. min⁻¹, at most 7° C. min⁻¹, at most 5° C. min⁻¹, at most 4.6° C. min⁻¹, at most 4.3° C. min⁻¹, at most 4.1° C. min⁻¹, at most 3.8° C. min⁻¹, at most 3.6° C. min⁻¹, at most 3.5° C. min⁻¹, at most 3.3° C. min⁻¹, at most 3.1° C. min⁻¹, at most 2.9° C. min⁻¹, at most 2.7° C. min⁻¹, at most 2.5° C. min⁻¹, at most 2.3° C. min⁻¹, or at most 2.2° C. min⁻¹. Moreover, the ramp rate to increase the temperature from the pre-heating temperature to the sintering temperature may be in a range including any of the minimum and maximum values noted herein.

In a further embodiment, a same or different ramp rate may be used to increase the temperature from room temperature to the pre-heating temperature and from the pre-heating temperature to the sintering temperature. In a particular example, a higher ramp rate may be utilized for increasing the temperature from the room temperature to the pre-heating temperature than from the pre-heating temperature to the sintering temperature. In another example, slower heating may be suited for sintering larger green bodies.

In an embodiment, the process 300 may include cooling the heated abrasive body after sintering is performed. In a further embodiment, cooling may include a plurality of cooling temperatures, cooling rates, or a combination thereof. For example, cooling may include cooling from the sintering temperature to a first cooling temperature, cooling from the first cooling temperature to a second cooling temperature lower than the first cooling temperature, and optionally, cooling from the second cooling temperature to a third cooling temperature lower than the second cooling temperature. Cooling may further include cooling the abrasive body to room temperature. In further instances, the second or the third cooling temperature may be room temperature. In at least one embodiment, cooling may be applied so that the abrasive body is cooled to room temperature from the sintering temperature without applying an intermediate cooling temperature.

In an embodiment, the process 300 may include cooling from the sintering temperature to the first cooling temperature. In certain instances, the agglomerates may be allowed to dwell at the first cooling temperature for a period of time. In a particular example, the first cooling temperature may be the pre-heating temperature. In a further instance, the first cooling temperature may be in a range of at least 450° C. and at most 650° C. In another instance, the dwelling time at the first cooling temperature may be in a range including at least 10 min and at most 2 hours, such as in a range including at least 25 minutes and at most 1.7 hours, or in a range including at least 40 minutes and at most 1.3 hours. In at least one example, dwelling at the first cooling temperature may not be performed.

In an embodiment, the process 100 may include a first cooling rate to facilitate temperature decreasing from the sintering temperature to the first cooling temperature. In an example, the first cooling rate may be at least 1.5° C. min⁻¹, at least 1.7° C. min⁻¹, at least 1.9° C. min⁻¹, at least 2.1° C. min⁻¹, at least 2.3° C. min⁻¹, at least 2.5° C. min⁻¹, at least 2.8° C. min⁻¹, at least 3° C. min⁻¹, at least 3.2° C. min⁻¹, at least 3.4° C. min⁻¹, at least 3.5° C. min⁻¹, or at least 3.7° C. min⁻¹. In another example, the first cooling rate may be at most 11° C. min⁻¹, at most 9° C. min⁻¹, at most 8° C. min⁻¹, at most 7° C. min⁻¹, at most 6° C. min⁻¹, at most 5° C. min⁻¹, at most 4.6° C. min⁻¹, at most 4.3° C. min⁻¹, at most 4.1° C. min⁻¹, at most 3.8° C. min⁻¹, at most 3.6° C. min⁻¹, or at most 3.5° C. min⁻¹. Moreover, the first cooling rate may be in a range including any of the minimum and maximum values noted herein.

In an embodiment, the process 300 may include a second cooling rate to facilitate temperature decreasing from the first cooling temperature to the second cooling temperature. In an example, the second cooling rate may be at least 0.1° C. min⁻¹, at least 0.2° C. min⁻¹, at least 0.3° C. min⁻¹, at least 0.4° C. min⁻¹, at least 0.5° C. min⁻¹, at least 0.6° C. min⁻¹, at least 0.7° C. min⁻¹, at least 0.8° C. min⁻¹, at least 0.9° C. min⁻¹, at least 1.2° C. min⁻¹, or at least 1.4° C. min⁻¹. In another example, the second cooling rate may be at most 5° C. min⁻¹, at most 4° C. min⁻¹, at most 3° C. min⁻¹, at most 2° C. min⁻¹, at most 1.6° C. min⁻¹, at most 1.5° C. min⁻¹, at most 1.3° C. min⁻¹, at most 1.1° C. min⁻¹, at most 1° C. min⁻¹, at most 0.8° C. min⁻¹, or at most 0.6° C. min⁻¹. Moreover, the second cooling rate may be in a range including any of the minimum and maximum values noted herein.

In an embodiment, the second cooling temperature may be in a range of at least 200° C. and at most 480° C., such as in a range of at least 260° C. and at most 420° C., or in a range of at least 310° C. and at most 390° C. In another embodiment, dwelling at the second cooling temperature may be optionally performed. For example, dwelling at the second cooling temperature may be at least 10 minutes to at most 2 hours. In another example, dwelling at the second cooling temperature may not be performed.

In an embodiment, the process 100 may include a third cooling rate to facilitate temperature decreasing from the second cooling temperature to the third cooling temperature. In an example, the second cooling rate may be at least 1.5° C. min⁻¹, at least 2° C. min⁻¹, at least 2.3° C. min⁻¹, at least 2.6° C. min⁻¹, at least 3° C. min⁻¹, at least 3.3° C. min⁻¹, at least 3.6° C. min⁻¹, at least 4° C. min⁻¹, at least 4.2° C. min⁻¹, at least 4.5° C. min⁻¹, at least 4.7° C. min⁻¹, at least 5° C. min⁻¹, at least 5.2° C. min⁻¹, at least 5.4° C. min⁻¹, or at least 5.6° C. min⁻¹. In another example, the third cooling rate may be at most 13° C. min⁻¹, at most 11° C. min⁻¹, at most 10° C. min⁻¹, at most 9.5° C. min⁻¹, at most 8.5° C. min⁻¹, at most 7° C. min⁻¹, at most 6.6° C. min⁻¹, at most 6.4° C. min⁻¹, at most 6.2° C. min⁻¹, at most 6° C. min⁻¹, at most 5.8° C. min⁻¹, at most 5.6° C. min⁻¹, at most 5.4° C. min⁻¹, or at most 5.1° C. min⁻¹. Moreover, the third cooling rate may be in a range including any of the minimum and maximum values noted herein. In a further example, the third temperature may be room temperature.

After cooling to room temperature, abrasive body may be finally formed including abrasive agglomerates contained within the bond material that may be a substantially uniform and continuous three-dimensional phase of material extending throughout the volume of the abrasive body. The finally-formed abrasive body may be incorporated into an abrasive article. It will be appreciated that the finally-formed abrasive body may have any suitable size and shape as known in the art and can be incorporated into various types of abrasive articles to form a fixed abrasive article suitable for conducting material removal operations, particularly material removal operations on titanium-containing metal and titanium-containing metal alloys, and more particularly, titanium-based metals and metal alloys, such as titanium aluminide, Ti-6Al-4V and the like. For example, the finally-formed abrasive body can be attached to a substrate, such as a hub of a wheel to facilitate formation of a bonded abrasive grinding wheel.

In an embodiment, the bond material may be similar to, substantially the same as, or different from the binder material. In a particular embodiment, the bond material may be essentially the same as the binder material.

In an embodiment, the bond material may include a crystalline phase, an amorphous phase, or any combination thereof. In a further embodiment, the bond material may include a particular content of an amorphous phase that may facilitate improved properties and/or performance of the abrasive article. For example, the bond material may include an amorphous phase of greater than 50 wt % for a total weight of the bond material, such as greater than 55 wt %, greater than 57 wt %, at least 60 wt %, at least 62 wt %, or at least 64 wt % for a total weight of the bond material. In another example, the bond material may comprise an amorphous phase of at most 75 wt % for a total weight of the bond material, at most 70 wt %, at most 65 wt %, at most 64 wt %, at most 63 wt %, or at most 60 wt % for a total weight of the bond material. Moreover, the bond material may include a content of the amorphous phase in a range including any of the minimum and maximum percentages noted herein.

In an embodiment, the bond material may include one or more crystalline phases. In a further embodiment, the bond material may include a particular total content of crystalline phases that may facilitate improved properties and/or performance of the abrasive article. In an example, the total content of crystalline phases may be in a content of at least 20 wt %, at least 26 wt %, at least 30 wt %, at least 33 wt %, at least 35 wt %, or at least 38 wt % for a total weight of the bond material. In another example, the bond material may comprise a total content of crystalline phases of less than 50 wt %, at most 40 wt %, at most 39 wt %, or at most 38 wt % for a total weight of the bond material. Moreover, the bond material may include a total content of crystalline phases in a range including any of the minimum and maximum percentages noted herein.

In an embodiment, the bond material may include a particular composition that may include one or more oxide including silica (SiO₂), alumina (Al₂O₃), boron oxide (B₂O₃), zirconium oxide (ZrO₂), one or more alkali oxide including potassium oxide (K₂O), lithium oxide (Li₂O), sodium oxide (Na₂O), or any combination thereof, alkaline earth oxide including magnesium oxide (MgO), barium oxide (BaO), calcium oxide (CaO), or any combination thereof, or any combination thereof. In a further embodiment, the oxides may be present in amorphous phase, crystalline phase, or both. In still another embodiment, one or more oxides may be formed into complex oxides including a plurality of cations.

In an embodiment, the bond material may include one or more crystalline phases including one or more of an oxide, silicate, or any combination thereof. In an aspect, the silicate may include one or more of an alkali metal element, a rare earth element, a Group 13 element (periodic table published on May 4, 2022 by IUPAC), or any combination thereof. In another aspect, the one or more crystalline phases may include zircon (ZrSiO₄), zirconia (ZrO₂), lithium-aluminum-silicate, or any combination thereof.

In an embodiment, the bond material may include crystalline zircon (ZrSiO₄). In a further embodiment, the bond material may include a particular content of zircon for a total weight of the bond material that may facilitate improved properties and/or performance of the abrasive article. For example, the bond material may comprise a content of zircon of greater than 0.5 wt %, such as at least 0.7 wt %, at least 0.9 wt %, at least 1.1 wt %, at least 1.3 wt %, at least 1.5 wt %, at least 1.8 wt %, at least 2.1 wt %, at least 2.3 wt %, at least 2.5 wt %, at least 2.9 wt %, at least 3.3 wt %, at least 3.5 wt %, at least 3.8 wt %, at least 4.1 wt %, at least 4.3 wt %, at least 4.5 wt %, at least 4.9 wt %, at least 5.3 wt %, at least 5.5 wt %, at least 5.8 wt %, at least 6.1 wt %, at least 6.3 wt %, or at least 6.5 wt % for a total weight of the bond material. In a further example, the bond material may comprise a content of zircon of less than 7.5 wt %, less than 7.3 wt %, at most 7.2 wt %, at most 7 wt %, at most 6.9 wt %, at most 6.6 wt %, at most 6.4 wt %, at most 6.1 wt %, at most 5.9 wt %, at most 5.6 wt %, at most 5.3 wt %, at most 5.1 wt %, at most 4.9 wt %, at most 4.7 wt %, at most 4.5 wt %, at most 4.2 wt %, at most 3.9 wt %, at most 3.6 wt %, at most 3.3 wt %, at most 3.1 wt %, at most 2.9 wt %, at most 2.7 wt %, at most 2.5 wt %, at most 2.3 wt %, or at most 2.2 wt % for a total weight of the bond material. Moreover, the bond material may include zircon in a content including any of the minimum and maximum percentages noted herein.

In a further embodiment, the bond material may include a particular content of a crystalline phase including zircon that may facilitate improved properties and/or performance of the abrasive article. For example, the crystalline phases including zircon may be in a content of greater than 1 wt % for a total weight of crystalline phases of the bond material, such as at least 1.3 wt %, at least 1.5 wt %, at least 1.8 wt %, at least 2.1 wt %, at least 2.3 wt %, at least 2.5 wt %, at least 2.9 wt %, at least 3.3 wt %, at least 3.5 wt %, at least 3.8 wt %, at least 4.1 wt %, at least 4.3 wt %, at least 4.5 wt %, at least 4.9 wt %, at least 5.3 wt %, at least 5.5 wt %, at least 5.8 wt %, at least 6.1 wt %, at least 6.3 wt %, at least 6.5 wt %, at least 6.8 wt %, or at least 7.2 wt % for a total weight of crystalline phases of the bond material. In another example, the crystalline phases including zircon (ZrSiO₄) may be present in a content of less than 21 wt %, at most 20 wt %, at most 18 wt %, at most 16 wt %, at most 14 wt %, at most 12 wt %, at most 10.5 wt %, at most 9.5 wt %, at most 8 wt %, at most 6.5 wt %, or at most 5.8 wt % for a total weight of crystalline phases of the bond material. Moreover, the bond material may include zircon in a crystalline phase in a content including any of the minimum and maximum percentages noted herein.

In a further embodiment, the bond material may comprise tetragonal zirconia (tZrO₂), monoclinic zirconia (mZrO₂), or any combination thereof in the crystalline phase.

In another embodiment, the bond material may include a particular content of a crystalline phase including tetragonal zircon that may facilitate improved structure, properties and/or performance of the abrasive agglomerates. For example, the crystalline phase including tetragonal zirconia (tZrO₂) may be present in a content of at least 0.3 wt % for a total weight of crystalline phases of the bond material, at least 0.5 wt %, at least 0.7 wt %, at least 1 wt %, at least 1.3 wt %, at least 1.5 wt %, at least 1.7 wt %, at least 1.8 wt %, at least 2.1 wt %, at least 2.5 wt %, at least 2.8 wt %, at least 3.2 wt %, at least 3.5 wt %, at least 3.8 wt %, at least 4.1 wt %, at least 4.3 wt %, at least 4.6 wt %, at least 4.8 wt %, or at least 5.1 wt % for a total weight of crystalline phases of the bond material. In another example, the crystalline phase including tetragonal zirconia ((ZrO₂) may be present in a content of at most 8.4 wt % for a total weight of crystalline phases of the bond material, at most 8.2 wt %, at most at most 8 wt %, at most 7.5 wt %, at most 7.2 wt %, at most 7 wt %, at most at most 6.8 wt %, at most 6.5 wt %, at most 6.2 wt %, at most 5.9 wt %, at most 5.7 wt %, at most 5.5 wt %, at most 5.2 wt %, at most 5 wt %, at most 4.9 wt %, at most 4.5 wt %, at most 4.2 wt %, or at most 4 wt % for a total weight of crystalline phases of the bond material. Moreover, the bond material may include the crystalline phase including tetragonal zirconia in a content including any of the minimum and maximum percentages noted herein.

In an embodiment, the bond material may comprise a tetragonal ZrO₂ (tZrO₂) in a content of at least 0.1 wt % for a total weight of the bond material, such as at least 0.3 wt %, at least 0.5 wt %, at least 0.8 wt %, at least 1 wt %, at least 1.2 wt %, at least 1.3 wt %, at least 1.5 wt %, at least 1.6 wt %, at least 1.8 wt %, at least 2 wt %, at least 2.2 wt %, at least 2.5 wt %, at least 2.8 wt %, at least 3.1 wt %, or at least 3.3 wt % for a total weight of the bond material. Alternatively or additionally, the bond material may comprise a tetragonal ZrO₂ (tZrO₂) in a content of at most 3.3 wt %, at most 3.2 wt %, at most 3 wt %, at most 2.9, at most 2.7 wt %, at most 2.5 wt %, at most 2.3 wt %, at most 2.1 wt %, at most 1.9 wt %, at most 1.8 wt %, or at most 1.6 wt % for a total weight of the bond material. Moreover, the bond material may include tetragonal zircon in a content including any of the minimum and maximum percentages noted herein. In a further embodiment, essentially all of tetragonal ZrO₂ (tZrO₂) may be present in the crystalline phase of the bond material.

In another embodiment, the bond material may include a particular content of a crystalline phase including monoclinic zircon that may facilitate improved structure, properties and/or performance of the abrasive agglomerates. For example, the crystalline phase including monoclinic zirconia (mZrO₂) may be present in a content of at least 0.1 wt % for for a total weight of crystalline phases of the bond material, at least 0.5 wt %, at least 0.7 wt %, at least 1 wt %, at least 1.3 wt %, at least 1.5 wt %, at least 1.7 wt %, at least 1.8 wt %, at least 2.1 wt %, at least 2.5 wt %, at least 2.7 wt %, at least 2.9 wt %, at least 3.1 wt %, at least 3.3 wt %, at least 3.5 wt %, at least 3.7 wt %, at least 3.9 wt %, or at least 4 wt % for a total weight of crystalline phases of the bond material. In another example, the crystalline phase including monoclinic zirconia (mZrO₂) may be present in a content of at most 73 wt % for a total weight of crystalline phases of the bond material, at most 69 wt %, at most at most 62 wt %, at most 58 wt %, at most 52 wt %, at most 47 wt %, at most at most 40 wt %, at most 35 wt %, at most 30 wt %, at most 25 wt %, at most 21 wt %, at most 16 wt %, at most 11 wt %, at most 8 wt %, at most 6 wt %, at most 4 wt %, at most 3.7 wt %, or at most 3.2 wt % for a total weight of crystalline phases of the bond material. Moreover, the bond material may include the crystalline phase including monoclinic zirconia in a content including any of the minimum and maximum percentages noted herein. In a further embodiment, essentially all of monoclinic ZrO₂ (mZrO₂) may be present in a crystalline phase of the bond material.

In another embodiment, the bond material may comprise monoclinic zirconia (mZrO₂) in a content of at least 0.1 wt % for at total weight of the bond material, such as at least 0.3 wt %, at least 0.5 wt %, at least 9.8 wt %, at least 1 wt %, at least 1.3 wt %, at least 1.5 wt %, at least 1.7 wt %, at least 1.8 wt %, or at least 2 wt % for at total weight of the bond material. Alternatively or additionally, the bond material may comprise monoclinic zirconia (mZrO₂) in a content of at most 3 wt % for at total weight of the bond material, at most 2.5 wt %, at most 2.2 wt %, at most 2 wt %, at most 1.8 wt %, at most 1.6, at most 1.5 wt %, at most 1.3 wt %, or at most 1.1 wt % for a total weight of the bond material. Moreover, the bond material may include monoclinic zirconia in a content including any of the minimum and maximum percentages noted herein.

In another embodiment, the the bond material may comprise a particular ratio C_{ZOT}/C_{ZOM} of a content of tetragonal ZrO₂ ((ZrO₂), C_{ZOT}, to a content of monoclinic ZrO₂ (mZrO₂), C_{ZOM}, that may facilitate improved properties and/or performance of the abrasive article, wherein the content of tetragonal ZrO₂ (tZrO₂), C_{ZOT}, is relative to a total weight content of crystalline phases of the bond material, and the content of monoclinic ZrO₂ (mZrO₂) C_{ZOM} is relative to the total weight content of crystalline phases of the bond material. For example, the ratio C_{ZOT}/C_{ZOM} may be at least 0.003, at least 0.03, at least 0.3, at least 0.7, at least 1, at least 1.1, at least 1.2, at least 1.4, at least 1.6, at least 1.8, at least 2, or at least 2.1. In another example, the ratio C_{ZOT}/C_{ZOM} may be less than 2.1, at most 2, at most 1.8, at most 1.6, at most 1.4, at most 1.3, at most 1.2, or at most 1. Moreover, the bond material may include a crystalline phase including the ratio C_{ZOT}/C_{ZOM} in a range including any of the minimum and maximum values noted herein.

In an embodiment, the bond material may comprise lithium-aluminum-silicate. In an example, one or more crystalline phases of the bond material may include lithium-aluminum-silicate. In a further example, lithium-aluminum-silicate may include a plurality of crystalline phases. In particular embodiments, the crystalline phase of the bond material may comprise a solid solution of Li₂O—Al₂O₃-nSiO₂, wherein n includes 2, 3, 4, 5, 6, 7, 8, 9, or any combination thereof. In another particular embodiment, the crystalline phase may include a solid solution of Li₂O—Al₂O₃-nSiO₂, wherein n may be selected from the group consisting of 2, 3, 5, 6, 7, 8 and 9. In a particular example, n may be greater than 4. In another particular example, n may include 6. In an example, the solid solution of Li₂O—Al₂O₃-nSiO₂ may include a crystalline phase including LiAlSi₃O₈. In an example, the solid solution of Li₂O—Al₂O₃-nSiO₂ may include a crystalline phase including Li_{0.25}Al_{0.25}Si_{0.75}O₂. In another example, the solid solution of Li₂O—Al₂O₃-nSiO₂ may include a first crystalline phase including LiAlSi₃O₈ and a second crystalline phase including Li_{0.25}Al_{0.25}Si_{0.75}O₂.

In an embodiment, the bond material may comprise a particular content of LiAlSi₃O₈ that may facilitate improved properties and/or performance of the abrasive article. For example, LiAlSi₃O₈ may be in a content of greater than 13 wt % for a total weight of the bond material, at least 14 wt %, at least 17 wt %, at least 20 wt %, at least 22 wt %, at least 25 wt %, at least 28 wt %, or at least 30 wt % for a total weight of the bond material. In another example, LiAlSi₃O₈ may be in a content of at most 45 wt % for a total weight of the bond material, such as at most 40 wt %, at most 38 wt %, at most 36 wt %, at most 32 wt %, at most 29 wt %, at most 27 wt %, at most 25 wt %, at most 22 wt %, at most 20 wt %, at most 16 wt %, or at most 14 wt % for a total weight of the bond material. Moreover, the bond material may include a content of LiAlSi₃O₈ in a range including any of the minimum and maximum percentages noted herein. In a further embodiment, essentially all of LiAlSi₃O₈ may be present in the crystalline phase of the bond material.

In another embodiment, the bond material may include a particular content of a crystalline phase including LiAlSi₃O₈ for a total content of crystalline phases in the bond material that may facilitate improved properties and/or performance of the abrasive article. For example, the crystalline phase including LiAlSi₃O₈ may be in a content of at least 30 wt % for a total weight of crystalline phases of the bond material, at least 35 wt %, at least 38 wt %, at least 42 wt %, at least 46 wt %, at least 50 wt %, at least 55 wt %, at least 60 wt %, at least 65 wt %, at least 70 wt %, at least 73 wt %, at least 76 wt %, at least 80 wt %, or at least 82 wt % for a total weight of crystalline phases of the bond material. In another example, the crystalline phase including LiAlSi₃O₈ may be in a content of at most 90 wt % for a total content of crystalline phases of the bond material, at most 87 wt %, at most 84 wt %, at most 81 wt %, at most 77 wt %, at most 74 wt %, at most 71 wt %, at most 65 wt %, at most 60 wt %, at most 55 wt %, at most 50 wt %, at most 45 wt %, at most 41 wt %, or at most 35 wt % for the total content of crystalline phases of the bond material. Moreover, the bond material may include the crystalline phase including LiAlSi₃O₈ in a content including any of the minimum and maximum percentages noted herein.

In an embodiment, the bond material may comprise a particular content of Li_{0.2.5}Al_{0.25}Si_{0.75}O₂ that may facilitate improved properties and/or performance of the abrasive article. For example, Li_{0.25}Al_{0.25}Si_{0.75}O₂ may be in a content of at least 0.4 wt % for a total weight of the bond material, at least 1 wt %, at least 1.3 wt %, at least 1.5 wt %, at least 1.7 wt %, at least 1.8 wt %, at least 2 wt %, at least 2.3 wt %, at least 2.5 wt %, at least 2.7 wt %, at least 3 wt %, at least 3.2 wt %, at least 3.4 wt %, at least 3.6 wt %, at least 3.9 wt %, at least 4.4 wt %, at least 4.9 wt %, at least 5.1 wt %, at least 5.4 wt %, at least 6 wt %, at least 8 wt %, at least 11 wt %, at least 14 wt %, at least 17 wt %, or at least 20 wt % for a total weight of the binder material. In another example, Li_{0.25}Al_{0.25}Si_{0.75}O₂ may be in a content of at most 20 wt %, at most 16 wt %, at most 13 wt %, at most 10 wt %, at most 7 wt %, at most 5.5 wt %, at most 5.1 wt %, at most 4.5 wt %, at most 3.5 wt %, at most 3 wt % at most 2 wt %, or at most 1.5 wt % for the total weight of the bond material. Moreover, the bond material may include a content of Li_{0.25}Al_{0.25}Si_{0.75}O₂ in a range including any of the minimum and maximum percentages noted herein. In a further embodiment, essentially all of Li_{0.25}Al_{0.25}Si_{0.75}O₂ may be present in the crystalline phase of the bond material.

In another embodiment, the bond material may include a particular content of a crystalline phase including Li_{0.25}Al_{0.25}Si_{0.75}O₂ for a total content of crystalline phases of the bond material that may facilitate improved properties and/or performance of the abrasive article. For example, the crystalline phase including Li_{0.25}Al_{0.25}Si_{0.75}O₂ may be in a content of at least 1.2 wt % for the total content of crystalline phases of the bond material, at least 2 wt %, at least 3 wt %, at least 5 wt %, at least 8 wt %, at least 10 wt %, at least 13 wt %, at least 16 wt %, at least 19 wt %, at least 22 wt %, at least 25 wt %, at least 30 wt %, at least 35 wt %, at least 40 wt %, at least 45 wt %, or at least 50 wt % for a total weight of crystalline phases of the bond material. In another example, the crystalline phase including Li_{0.25}Al_{0.25}Si_{0.75}O₂ may be in a content of at most 51 wt % for a total content of crystalline phases of the bond material, at most 47 wt %, at most 42 wt %, at most 39 at %, at most 34 wt %, at most 31 wt %, at most 28 wt %, at most 24 wt %, at most 21 wt %, at most 18 wt %, at most 15 wt %, at most 12 wt %, at most 10 wt %, at most 8 wt %, at most 5 wt %, or at most 2 wt % for a total weight of crystalline phases of the bond material. Moreover, the bond material may include the crystalline phase including Li_{0.25}Al_{0.25}Si_{0.75}O₂ in a content including any of the minimum and maximum percentages noted herein.

In an embodiment, the crystalline phase of the bond material may comprise a particular ratio C_{SI1}/C_{SI2} of a first content of LiAlSi₃O₈, C_{SI1}, to a second content of Li_{0.25}Al_{0.25}Si_{0.75}O₂, C_{SI2}, that may facilitate improved properties and/or performance of the abrasive article, wherein the first content of LiAlSi₃O₈, C_{SI1}, is relative to the total crystalline phase content of the bond material, and the second content of Li_{0.25}Al_{0.25}Si_{0.75}O₂, C_{SI2}, is relative to the total crystalline phase content of the bond material. In an example, the ratio C_{SI1}/C_{SI2} may be greater than 0.65, at least 0.8, at least 1, at least 1.2, at least 1.5, at least 2, at least 2.5, at least 3, at least 3.5, at least 4, at least 4.5, at least 5, at least 5.5, at least 7, at least 9, at least 12, at least 15, at least 20, at least 30, at least 40, at least 50, at least 60, or at least 70. In another example, the ratio C_{SI1}/C_{SI2} is at most 90, at most 86, at most 84, at most 80, at most 75, at most 70, at most 65, at most 60, at most 55, at most 50, at most 45, at most 40, at most 35, at most 30, at most 20, at most 15, at most 10, at most 8, at most 5, or at most 3. Moreover, the bond material may include the C_{SI1}/C_{SI2} in a range including any of the minimum and maximum percentages noted herein.

In an embodiment, the bond material may be essentially free of mullite (Al₂(Al_{2.8}Si_{1.2})O_{9.6} or Al₆Si₂O₁₃), anorthite (Na_{0.4}Ca_{0.6}Al_{1.6}Si_{2.4}O₈), quartz (SiO₂), crystalline LiAlSi₂O₆ (Li₂O—Al₂O₃-nSiO₂ n=4), or any combination thereof. In another embodiment, the bond material may include silica, wherein essentially all of silica may be present in the amorphous phase of the bond material. In a particular embodiment, the bond material may be essentially free of quartz (SiO₂). In another particular embodiment, the bond material may be essentially free of mullite (Al₂(Al_{2.8}Si_{1.2})O_{9.6} and Al₆Si₂O₁₃). In a further particular embodiment, the bond material may be essentially free of anorthite (Na_{0.4}Ca_{0.6}Al_{1.6}Si_{2.4}O₈). In still another particular embodiment, the bond material may be essentially free of crystalline LiAlSi₂O₆ (Li₂O—Al₂O₃-nSiO₂ n=4).

In an embodiment, the bond material may include an amorphous phase including a silicate. In another embodiment, the bond material may include a silicate glassy phase including one or more or all of the elements selected from Si, O, Al, Ba, Mg. Li, Ba, and K. In a further embodiment, the bond material may include Zr in the crystalline phase, amorphous phase, or both. In a particular embodiment, the majority or essentially all of Zr may be present in the crystalline phase.

It is to be appreciated the binder material of the abrasive agglomerates may include any one or more or all of the features described with respect to the bond material in embodiments herein.

FIG. 4 includes a SEM image of a portion of a bond material representative of embodiments herein. As illustrated, the bond material 404 includes crystalline phases of zircon 431, zirconia 433, and lithium-aluminum-silicate 432, and an amorphous phase 414. In an embodiment, crystalline phases described in embodiments herein may constitute of crystals. For example, the crystalline phases including zicon may constitute of zircon crystals. In another example, the crystalline phase including ziconia may consititute of zirconia crystals, which may appear very fine, as demosntrated in FIG. 4.

In an embodiment, the bond material may include a particular coefficient of thermal expansion (CTE) that may facilitate improved properties and/or performance of the abrasive article. In an aspect, the bond material may include a particular CTE for a temperature from 20° C. to 500° C. that may facilitate improved properties and performance of the abrasive article. In an example, the bond material may comprise a coefficient of thermal expansion (CTE) of less than 7.8 ppm/° C., such as at most 7.5 ppm/° C., at most 7.2 ppm/° C., at most 7 ppm/° C., at most 6.7 ppm/° C., at most 6.4 ppm/° C., at most 6.1 ppm/° C., at most 5 ppm/° C., at most 4.5 ppm/° C., at most 4.1 ppm/° C., at most 3.8 ppm/° C., at least 3.4 ppm/° C., at most 3.2 ppm/° C., at most 3 ppm/° C., or at most 2.8 ppm/° C. In another example, the bond material may comprise a coefficient of thermal expansion (CTE) of at least 1 ppm/° C., at least 1.4 ppm/° C., at least 1.6 ppm/° C., at least 1.8 ppm/° C., at least 2.1 ppm/° C., at least 2.4 ppm/° C., at least 2.6 ppm/° C., at least 2.8 ppm/° C., at least 3.0 ppm/° C., or at least 3.2 ppm/° C. Moreover, the bond material may include a coefficient of thermal expansion (CTE) in a range including any of the minimum and maximum values noted herein.

In an embodiment, the abrasive body may include a particular content of abrasive agglomerates that may facilitate improved properties and/or performance of the abrasive article. In an example, the abrasive body may comprise at least 30 vol % of abrasive agglomerates for a total volume of the body, at least 33 vol %, at least 35 vol %, at least 36 vol %, at least 38 vol %, at least 40 vol %, or at least 42 vol % for a total volume of the body. In another example, the abrasive body may comprise at most 63 vol % of abrasive agglomerates for a total volume of the body, at most 60 vol %, at most 57 vol %, at most 52 vol %, at most 48 vol %, at most 45 vol %, at most 42 vol %, at most 40 vol %, or at most 38 vol % for a total volume of the body. Moreover, the abrasive body may include a content of abrasive agglomerates in a range including any of the minimum and maximum percentages noted herein. A skilled artisan appreciates that during mixing abrasive agglomerates may be broken and that broken pieces may be in the form of unagglomerated particles and present in the finally formed body. Accordingly, in those instances, the abrasive body may include a low amount of unagglomerated particles, such as at most 10 wt % of unagglomerated particles, at most 8 wt %, at most 5 wt %, at most 3 wt %, at most 2 wt %, or at most 0.5 wt % of unagglomerated particles for the total weight of abrasive particles in the body. In a particular embodiment, the unagglomerated particles may consist essentially of cubic boron nitride particles. In particular examples, the abrasive body may be essentially free of unagglomerated abrasive particles.

In an embodiment, the abrasive body may include a particular content of the bond material that may facilitate improved properties and/or performance of the abrasive article. In an example, the abrasive body may comprise at most 24 vol % of the bond material for a total volume of the body, at most 22 vol %, at most 20 vol %, at most 18 vol %, at most 16 vol %, at most 14 vol %, at most 12 vol %, at most 10 vol %, at most 8 vol %, at most 6 vol %, at most 4 vol %, or at most 3 vol % for a total volume of the body. In a further example, the body may comprise at least 1 vol % of the bond material for a total volume of the body, at least 3 vol %, at least 5 vol %, at least 6.5 vol %, at least 8 vol %, at least 9.5 vol %, at least 12 vol %, at least 14 vol %, at least 16 vol %, or at least 18 vol % for a total volume of the body. Moreover, the abrasive body may include a content of the bond material in a range including any of the minimum and maximum percentages noted herein. In a particular embodiment, the bond material may consist essentially of a vitrified material.

In an embodiment, the abrasive body may include a total content of crystalline phases present in the abrasive body. In another embodiment, the total content of crystalline phases of the abrasive body may include contents of crystalline phases of the bond material, contents of crystalline phases of the binder material, and contents of one or more crystalline phases of the abrasive particles. In certain instances, additives may be included in the abrasive body and may include crystalline phases. Accordingly in those instances, the total contents of crystalline phases of the abrasive body may include crystalline phases of additives. The crystalline phases of the abrasive body and contents thereof can be detected by X-ray diffraction analysis.

In an embodiment, the abrasive body may include a particular content of a crystalline phase including ZrSiO₄ that may facilitate improved formation and/or improved property and/or performance of the abrasive article. In a further embodiment, the abrasive body may include a content of the crystalline phase including ZrSiO₄ for a total content of crystalline phases of the abrasive body. In an example, the abrasive body may include greater than 0.1 wt % of the crystalline phase including ZrSiO₄ for the total total content of crystalline phases of the abrasive body, such as at least 0.2 wt %, at least 0.4 wt %, at least 0.5 wt %, at least 0.6 wt %, at least 0.8 wt %, at least 0.9 wt %, or at least 1.2 wt % for the total content of crystalline phases of the abrasive body. In another example, the abrasive body may include at most 5 wt % of the crystalline phase including ZrSiO₄ for a total content of crystalline phases of the abrasive body, such as at most 4.8 wt %, at most 4.5 wt %, at most 4.3 wt %, at most 4 wt %, at most 3.8 wt %, at most 3.5 wt %, at most 3.3 wt %, at most 3.1 wt %, at most 2.7 wt %, at most 2.5 wt %, at most 2.2 wt %, at most 1.9 wt %, at most 1.6 wt %, or at most 1.5 wt % for a total content of crystalline phases of the abrasive body. Moreover, the abrasive body may include a content of the crystalline phase including ZrSiO₄ in a range including any of the minimum and maximum percentages noted herein.

In an embodiment, the abrasive body may include a particular content of a crystalline phase including ZrO₂ that may facilitate improved formation and/or improved property and/or performance of the abrasive article. In an example, the abrasive body may include at least 0.02 wt % of the crystalline phase including ZrO₂ for the total total content of crystalline phases of the abrasive body, such as at least 0.03 wt %, at least 0.05 wt %, at least 0.07 wt %, at least 0.08 wt %, at least 0.09 wt %, or at least 0.1 wt % for the total content of crystalline phases of the abrasive body. In another example, the abrasive body may include at most 2 wt % of the crystalline phase including ZrO₂ for a total content of crystalline phases of the abrasive body, such as at most 1.8 wt %, at most 1.5 wt %, at most 1.3 wt %, at most 1 wt %, at most 0.9 wt %, at most 0.8 wt %, at most 0.6 wt %, at most 0.5 wt %, at most 0.3 wt %, at most 0.2 wt %, or at most 0.1 wt % for a total content of crystalline phases of the abrasive body. Moreover, the abrasive body may include a content of the crystalline phase including ZrO₂ in a range including any of the minimum and maximum percentages noted herein.

In a further embodiment, the abrasive body may include a content of the crystalline phase including monoclinic ZrO₂ for a total content of crystalline phases of the abrasive body. In still another embodiment, the abrasive body may include a content of the crystalline phase including tetragonal ZrO₂ for a total content of crystalline phases of the abrasive body. In a further embodiment, the abrasive body may include a content of the crystalline phase including monoclinic ZrO₂ and a content of the crystalline phase including tetragonal ZrO₂ for a total content of crystalline phases of the abrasive body.

In a further embodiment, the abrasive body may include a content of the crystalline phase including monoclinic ZrO₂ of at least 0.01 wt % for the total total content of crystalline phases of the abrasive body, such as at least 0.02 wt %, at least 0.03 wt %, at least 0.05 wt %, at least 0.07 wt %, at least 0.08 wt %, at least 0.09 wt %, or at least 0.1 wt % for the total content of crystalline phases of the abrasive body. Alternatively or additionally, the abrasive body may include at most 2 wt % of the crystalline phase including monoclinic ZrO₂ for a total content of crystalline phases of the abrasive body, such as at most 1.8 wt %, at most 1.5 wt %, at most 1.3 wt %, at most 1 wt %, at most 0.9 wt %, at most 0.8 wt %, at most 0.6 wt %, at most 0.5 wt %, at most 0.3 wt %, at most 0.2 wt %, or at most 0.1 wt % for a total content of crystalline phases of the abrasive body. Moreover, the abrasive body may include a content of the crystalline phase including monoclinic ZrO₂ in a range including any of the minimum and maximum percentages noted herein.

In a further embodiment, the abrasive body may include a content of the crystalline phase including tetragonal ZrO₂ of at least 0.001 wt % for the total total content of crystalline phases of the abrasive body, such as at least 0.005 wt %, at least 0.01 wt %, at least 0.02 wt %, at least 0.03 wt %, at least 0.05 wt %, at least 0.07 wt %, at least 0.08 wt %, at least 0.09 wt %, or at least 0.1 wt % for the total content of crystalline phases of the abrasive body. Alternatively or additionally, the abrasive body may include at most 2 wt % of the crystalline phase including tetragonal ZrO₂ for a total content of crystalline phases of the abrasive body, such as at most 1.8 wt %, at most 1.5 wt %, at most 1.3 wt %, at most 1 wt %, at most 0.9 wt %, at most 0.8 wt %, at most 0.6 wt %, at most 0.5 wt %, at most 0.3 wt %, at most 0.2 wt %, at most 0.1 wt %, or at most 0.07 wt % for a total content of crystalline phases of the abrasive body. Moreover, the abrasive body may include a content of the crystalline phase including tetragonal ZrO₂ in a range including any of the minimum and maximum percentages noted herein.

In an embodiment, the abrasive body may include a particular content of a crystalline phase including LiAlSi₃O₈ that may facilitate improved formation and/or improved property and/or performance of the abrasive article. In an example, the abrasive body may include at least 0.5 wt % of the crystalline phase including LiAlSi₃O₈ for the total total content of crystalline phases of the abrasive body, such as at least 0.8 wt %, at least 1 wt %, at least 1.5 wt %, at least 2 wt %, at least 2.5 wt %, at least 3 wt %, at least 3.5 wt %, at least 4 wt %, at least 4.5 wt %, or at least 5 wt % for the total content of crystalline phases of the abrasive body. In another example, the abrasive body may include at most 10 wt % of the crystalline phase including LiAlSi₃O₈ for a total content of crystalline phases of the abrasive body, such as at most 9 wt %, at most 8 wt %, at most 7.5 wt %, at most 7 wt %, at most 6.5 wt %, at most 6 wt %, at most 5.5 wt %, at most 5 wt %, or at most 4.8 wt % for a total content of crystalline phases of the abrasive body. Moreover, the abrasive body may include a content of the crystalline phase including LiAlSi₃O₈ in a range including any of the minimum and maximum percentages noted herein.

In an embodiment, the abrasive body may include a particular porosity that may facilitate improved properties and/or performance of the abrasive article. In an example, the abrasive body may comprise a porosity of at least 35 vol % for a total volume of the body, at least 43 vol %, at least 45 vol %, at least 47 vol %, at least 50 vol %, at least 53 vol %, at least 55 vol %, at least 57 vol %, at least 59 vol %, or at least 61 vol % for a total volume of the body. In another example, the body may comprise a porosity of at 70 vol % for a total volume of the body, at most 67 vol %, at most 65 vol %, at most 62 vol %, at most 60 vol %, at most 58 vol %, at most 55 vol %, or at most 53 vol % for a total volume of the body. Moreover, the abrasive body may include a porosity in a range including any of the minimum and maximum percentages noted herein.

In an embodiment, the abrasive body may have a particular amount of open porosity (also referred to as “interconnected porosity”) that can facilitate improved performance of the abrasive article. For example, the abrasive body may include open porosity, wherein at least 20 vol % of the total porosity (vol %) of the abrasive body can be interconnected porosity. Interconnected porosity defines a series of interconnected channels extending through the abrasive body. Open porosity or interconnected porosity can be distinct from closed porosity, which is defined as discrete pores within the body that are not connected to adjacent pores and do not form an interconnected network of channels through the abrasive body. Closed porosity does not allow a fluid to flow freely through the volume of the body. In another instance, the abrasive body can include at least 30 vol %, such as at least 40 vol %, at least 50 vol %, at least 60 vol %, at least 70 vol %, at least 80 vol %, at least 90 vol %, or even at least 95 vol % of interconnected porosity for the total volume or porosity in the abrasive body. In at least one embodiment, essentially all the porosity of the body can be interconnected porosity. Still, in at least one non-limiting embodiment, the abrasive body may have at most 99 vol %, such as at most 95 vol %, or even at most 90 vol % of the total porosity that may be interconnected porosity. It will be appreciated that the abrasive body can include a content of interconnected porosity within a range including any of the minimum and maximum values noted above.

In another embodiment, the abrasive body may include a particular content of permeability as measured by the average Darcy's number that may facilitate improved properties and/or performance of the abrasive article. In an example, the abrasive body may comprise a permeability of at least 15 Darcy, at least 30 Darcy, at least 35 Darcy, at least 40 Darcy, at least 45 Darcy, at least 50 Darcy, or at least 55 Darcy. In another example, the abrasive body may comprise a permeability of at most 70 Darcy, at most 67 Darcy, at most 62 Darcy, at most 60 Darcy, at most 58 Darcy, at most 55 Darcy, at most 52 Darcy, or at most 50 Darcy. It will be appreciated that the abrasive body may have a permeability within a range including any of the minimum and maximum values noted herein.

Darcy's number is measured according to an air permeability test, as detailed in ASTM C577 and developed by subcommittee and published at C08.03 Book of Standards Volume: 15.01. A sample is installed dry into a Gas Permeameter GP-100A from PMI Inc. of Ithaca, NY. The sample has a flat surface and thickness of 0.762 cm. The diameter of the O-ring which holds the sample determines the sample diameter, which is 2.85 cm. Air is forced to flow through the test sample at room temperature. A range of different pressure differentials from 0 to 3 psi are applied to the surface of the sample and the flow of the air through the sample is measured. The measurements of flow rate and the corresponding pressure drops (differential pressure) for the range of pressures from 0 to 3 psi is used to calculate the average Darcy's number, which defines the permeability of the abrasive body.

Darcy's number (C) is calculated according to the equation C=(8FTV)/[πD²(P²−1)], and defines the permeability through a porous medium, where “F” represents the flow, “T” represents the sample thickness (i.e., 0.762 cm), “V” represents the viscosity of the gas flowing through the sample (i.e., air having a viscosity of 0.0185 MPa's) “D” represents the diameter of the air hose contacting the sample (i.e., 2.54 cm), “P” represents the pressure gradient across the sample thickness.

In an embodiment, the abrasive body may include improved properties including Modulus of Rupture (MOR), ratio of MOR to permeability, Modulus of Elasticity, Rockwell hardness including HRR, HRL, or both, a ratio of Rockwell hardness to permeability, or any combination thereof, compared to conventional abrasive articles utilized in the same material removal applications.

In an embodiment, the abrasive body may comprise a Modulus of Rupture of at least 14 MPa, at least 15 MPa, at least 17 MPa, at least 18 MPa, at least 19 MPa, at least 20 MPa, or at least 21 MPa for a permeability of at least 15 Darcy. Additionally or alternatively, the abrasive body may comprise a Modulus of Rupture of at most 80 MPa, at most 70 MPa, at most 60 MPa, at most 50 MPa, at most 40 MPa, at most 30 MPa, at most 28 MPa, at most 25 MPa, at most 22 MPa, at most 20 MPa, or at most 18 MPa for a permeability of at least 15 Darcy. Moreover, the abrasive body may comprise a Modulus of Rupture in a range including any of the minimum and maximum values noted herein. In this disclosure, reference to Modulus of Rupture is reference to 4-point flexure strength determined according to ASTM C1161.

In an embodiment, the abrasive body may comprise a ratio of MOR/Peam of at most 1.5, at most 1.3, at most 1.1, at most 1, at most 0.8, at most 0.6, at most 0.5, or at most 0.3, wherein Peam represents permeability of the body. Additionally or alternatively, the abrasive body may comprise a ratio of MOR/Peam of at least 0.05, at least 0.07, at least 0.09, at least 0.1, at least 0.12, at least 0.15, at least 0.18, at least 0.2, at least 0.22, at least 0.24, at least 0.26, at least 0.28, at least 0.3, or at least 0.5. Moreover, the abrasive body may comprise a ratio of MOR (Modulus of Rupture) to permeability, MOR/Peam, in a range including any of the minimum and maximum values noted herein.

In an embodiment, the abrasive body may comprise a Modulus of Elasticity (MOE) of at least 6 GPa, at least 8 GPa, at least 10 GPa, at least 12 GPa, or at least 15 GPa. Additionally or alternatively, the abrasive may comprise a Modulus of Elasticity of at most 65 GPa, at most 28 GPa, at most 25 GPa, at most 23 GPa, at most 21 GPa, or at most 18 GPa. Moreover, the abrasive body may comprise a Modulus of Elasticity (MOE) in a range including any of the minimum and maximum values noted herein.

In an embodiment, the abrasive body may comprises a ratio of MOE to permeability, MOE/Peam, of at most 5, at most 1.3, at most 1.1, at most 1, at most 0.8, at most 0.6, at most 0.5, or at most 0.3, wherein Peam represents permeability of the abrasive body. Additionally or alternatively, the abrasive body may comprise a ratio of MOE/Peam of at least 0.05, at least 0.08, at least 0.1, at least 0.12, at least 0.15, at least 0.18, at least 0.2, at least 0.22, at least 0.24, at least 0.26, at least 0.28, or at least 0.3. Moreover, the abrasive body may comprise a ratio of MOE (Modulus of Elasticity) to permeability, MOE/Peam, in a range including any of the minimum and maximum values noted herein.

In an embodiment, the abrasive body may comprises a Rockwell hardness including HRR, HRL, or both of at least 40, at least 40, at least 43, at least 45, at least 50, at least 55, at least 58, at least 60, at least 62, at least 66, at least 70, at least 72, at least 75, at least 76, at least 80, at least 85, at least 88, at least 90, or at least 92. Additionally or alternatively, the body may comprise a Rockwell hardness (HRR, HRL, or both) of at most 120, at most 110, at most 100, at most 97, at most 95, at most 92, at most 88, at most 84, at most 80, at most 78, at most 76, at most 73, at most 71, at most 68, at most 65, at most 62, at most 60, at most 58, at most 55, at most 53, at most 50, at most 47, or at most 45. Moreover, the abrasive body may comprise a Rockwell hardness including HRR, HRL, or both in a range including any of the minimum and maximum values noted herein. In this disclosure, the Rockwell hardness HRR is determined following the testing method noted in ASTM E18-22, but using 60 kg load and an indenter of a ½″ ball; and HRL is determined using 60 kg load and an indenter of a ¼″ ball.

In an embodiment, the abrasive body may comprise a ratio of Rockwell hardness (HRR, HRL, or both) to permeability, RH/Peam, of at most 9, at most 4.2, at most 3.9, at most 3.6, at most 3.2, at most 2.8, at most 2.5, at most 2.2, at most 2, at most 1.7, at most 1.5, at most 1.3, at most 1.1, at most 0.9, or at most 0.8, wherein RH represents a Rockwell hardness of the body, and Peam represents permeability of the body. Additionally or alternatively, the body comprises a ratio of RH/Peam of at least 0.3, at least 0.5, at least 0.8, at least 1, at least 1.2, at least 1.5, at least 1.8, at least 2, or at least 2.2. Moreover, the abrasive body may comprise a ratio of Rockwell hardness to permeability, RH/Peam, in a range including any of the minimum and maximum values noted herein.

In further embodiments, the abrasive articles of embodiments herein are capable of grinding/cutting at high material removal rates without producing burn on workpieces, while conventional abrasive articles can cause burn at the same grinding/cutting conditions. An exemplary operation may include the use of coolant, such as oil-based or water-based coolant and a workpiece including any of the materials discussed in this application with respect to workpieces. A further example of the workpieces may have a thermal conductivity of 5-20 W/m/K, density of 3-12 g/cc, or any combination thereof. In a particular exemplary operation, the workpieces may include Inconel and the material removal rate may be 1 in³/in/min using an oil based coolant.

Many different aspects and embodiments are possible. Some of those aspects and embodiments are described below. After reading this specification, skilled artisans will appreciate that those aspects and embodiments are only illustrative and do not limit the scope of the present invention. Embodiments may be in accordance with any one or more of the items as listed below.

### Embodiment 1

An abrasive article, comprising a body comprising:
abrasive agglomerates bonded by a bond material,
wherein the abrasive agglomerates comprise abrasive particles including cubic boron nitride,
wherein the bond material comprises at least one of the following:
a content of zircon of greater than 0.5 wt % and less than 7.25 wt % for a total weight of the bond material;
a ratio C_{ZOT}/CZOM of a content of tetragonal ZrO₂, C_{ZOT}, to a content of monoclinic ZrO₂, C_{ZOM}, of at least 0.003 and less than 2.1, wherein the content of ZrO₂ tetragonal phase, C_{ZOT}, is relative to a total crystalline phase content of the bond material, and the content of ZrO₂ monoclinic phase C_{ZOM} is relative to the total crystalline phase content of the bond material;
a ratio of a content of a first lithium-aluminum-silicate isoform, CSI1, to a content of a second lithium-aluminum-silicate isoform, CSI2, of greater than 0.65 and at most 84, wherein the content of the first lithium-aluminum-silicate isoform, CSI1, is relative to the total crystalline phase content of the bond material, and the content of the second lithium-aluminum-silicate isoform, CSI2, is relative to a total crystalline phase content of bond material;
any combination thereof.

### Embodiment 2

An abrasive article, comprising a body comprising:
a bond material comprising an inorganic material;
abrasive agglomerates bonded by the bond material, wherein the abrasive agglomerates comprise abrasive particles including cubic boron nitride and a binder material;
a porosity in a content of at least 40 vol % for a total volume of the body; and
at least one of a Modulus of Rupture of at least 14 MPa, a Modulus of Elasticity of at least 6 GPa, a flexure strength of at least 14 MPa, a Rockwell hardness of at least 40, or a combination thereof.

### Embodiment 3

An abrasive article, comprising a body comprising:
a bond material comprising an inorganic material;
abrasive agglomerates bonded by the bond material, wherein the abrasive agglomerates comprise abrasive particles including cubic boron nitride and a binder material;
a permeability of at least 15 Darcy; and
at least one of a Modulus of Rupture of at least 14 MPa, a Modulus of Elasticity of at least 6 GPa, Rockwell hardness of at least 40, flexural strength of at least 14 MPa, or a combination thereof.

### Embodiment 4

The abrasive article of any one of embodiments 1 to 3, wherein the bond material comprises a content of zircon of greater than 0.5 wt %, such as at least 0.7 wt %, at least 0.9 wt %, at least 1.1 wt %, at least 1.3 wt %, at least 1.5 wt %, at least 1.8 wt %, at least 2.1 wt %, at least 2.3 wt %, at least 2.5 wt %, at least 2.9 wt %, at least 3.3 wt %, at least 3.5 wt %, at least 3.8 wt %, at least 4.1 wt %, at least 4.3 wt %, at least 4.5 wt %, at least 4.9 wt %, at least 5.3 wt %, at least 5.5 wt %, at least 5.8 wt %, at least 6.1 wt %, at least 6.3 wt %, or at least 6.5 wt % for a total weight of the bond material.

### Embodiment 5

The abrasive article of any one of embodiments 1 to 4, wherein the bond material comprises a content of zircon of less than 7.5 wt %, less than 7.3 wt %, at most 7.2 wt %, at most 7 wt %, at most 6.9 wt %, at most 6.6 wt %, at most 6.4 wt %, at most 6.1 wt %, at most 5.9 wt %, at most 5.6 wt %, at most 5.3 wt %, at most 5.1 wt %, at most 4.9 wt %, at most 4.7 wt %, at most 4.5 wt %, at most 4.2 wt %, at most 3.9 wt %, at most 3.6 wt %, at most 3.3 wt %, at most 3.1 wt %, at most 2.9 wt %, at most 2.7 wt %, at most 2.5 wt %, at most 2.3 wt %, or at most 2.2 wt % for a total weight of the bond material.

### Embodiment 6

The abrasive article of any one of embodiments 1 to 5, wherein the bond material comprises an amorphous phase, a crystalline phase, or any combination thereof.

### Embodiment 7

The abrasive article of any one of embodiments 1 to 6, wherein the bond material comprises an amorphous phase.

### Embodiment 8

The abrasive article of any one of embodiments 1 to 7, wherein the bond material comprises an amorphous phase of greater than 50 wt % for a total weight of the bond material, such as at least 55 wt %, greater than 55 wt %, greater than 57 wt %, at least 60 wt %, at least 62 wt %, or at least 64 wt % for a total weight of the bond material.

### Embodiment 9

The abrasive article of any one of embodiments 1 to 8, wherein the bond material comprises an amorphous phase of at most 75 wt % for a total weight of the bond material, at most 70 wt %, at most 65 wt %, at most 64 wt %, at most 63 wt %, or at most 60 wt % for a total weight of the bond material.

### Embodiment 10

The abrasive article of any one of embodiments 1 to 9, wherein the bond material comprises a crystalline phase.

### Embodiment 11

The abrasive article of any one of embodiments 1 to 10, wherein the bond material comprises a crystalline phase including one or more of an oxide, silicate, or any combination thereof.

### Embodiment 12

The abrasive article of any one of embodiments 1 to 11, wherein the bond material comprises a crystalline phase including one or more silicate including one or more of an alkali metal element, a rare earth element, a Group 13 element (periodic table published on May 4, 2022 by IUPAC), or any combination thereof.

### Embodiment 13

The abrasive article of any one of embodiments 1 to 12, wherein the bond material comprises a crystalline phase including zircon (ZrSiO₄), zirconia (ZrO₂), lithium-aluminum-silicate, or any combination thereof.

### Embodiment 14

The abrasive article of any one of embodiments 10 to 13, wherein zircon (ZrSiO₄) is present in the crystalline phase in a content of greater than 1 wt % for a total weight of the crystalline phase, at least 1.3 wt %, at least 1.5 wt %, at least 1.8 wt %, at least 2.1 wt %, at least 2.3 wt %, at least 2.5 wt %, at least 2.9 wt %, at least 3.3 wt %, at least 3.5 wt %, at least 3.8 wt %, at least 4.1 wt %, at least 4.3 wt %, at least 4.5 wt %, at least 4.9 wt %, at least 5.3 wt %, at least 5.5 wt %, at least 5.8 wt %, at least 6.1 wt %, at least 6.3 wt %, at least 6.5 wt %, at least 6.8 wt %, or at least 7.2 wt % for a total weight of the crystalline phase.

### Embodiment 15

The abrasive article of embodiment 13 or 14, wherein zircon (ZrSiO₄) is present in the crystalline phase in a content of less than 21 wt %, at most 20 wt %, at most 18 wt %, at most 16 wt %, at most 14 wt %, at most 12 wt %, at most 10.5 wt %, at most 9.5 wt %, at most 8 wt %, at most 6.5 wt %, or at most 5.8 wt % for a total weight of the crystalline phase.

### Embodiment 16

The abrasive article of any one of embodiments 1 to 15, wherein the bond material comprises a crystalline phase including tetragonal zirconia (tZrO₂), monoclinic zirconia (mZrO₂), or any combination thereof.

### Embodiment 17

The abrasive article of any one of embodiments 10 to 16, wherein tetragonal zirconia (tZrO₂) is present in the crystalline phase in a content of at least 0.3 wt % for a total weight of the crystalline phase, at least 0.5 wt %, at least 0.7 wt %, at least 1 wt %, at least 1.3 wt %, at least 1.5 wt %, at least 1.7 wt %, at least 1.8 wt %, at least 2.1 wt %, at least 2.5 wt %, at least 2.8 wt %, at least 3.2 wt %, at least 3.5 wt %, at least 3.8 wt %, at least 4.1 wt %, at least 4.3 wt %, at least 4.6 wt %, at least 4.8 wt %, or at least 5.1 wt % for a total weight of the crystalline phase.

### Embodiment 18

The abrasive article of any one of embodiments 10 to 17, wherein tetragonal zirconia (tZrO₂) is present in the crystalline phase in a content of at most 8.4 wt % for a total weight of the crystalline phase, at most 8.2 wt %, at most at most 8 wt %, at most 7.5 wt %, at most 7.2 wt %, at most 7 wt %, at most at most 6.8 wt %, at most 6.5 wt %, at most 6.2 wt %, at most 5.9 wt %, at most 5.7 wt %, at most 5.5 wt %, at most 5.2 wt %, at most 5 wt %, at most 4.9, at most 4.5 wt %, at most 4.2 wt %, or at most 4 wt % for a total weight of the crystalline phase.

### Embodiment 19

The abrasive article of any one of embodiments 1 to 18, wherein the bond material comprises a tetragonal ZrO₂ (tZrO₂) in a content of at least 0.1 wt % for a total weight of the bond material, at least 0.3 wt %, at least 0.5 wt %, at least 0.8 wt %, at least 1 wt %, at least 1.2 wt %, at least 1.3 wt %, at least 1.5 wt %, at least 1.6 wt %, at least 1.8 wt %, at least 2 wt %, at least 2.2 wt %, at least 2.5 wt %, at least 2.8 wt %, at least 3.1 wt %, or at least 3.3 wt % for a total weight of the bond material.

### Embodiment 20

The abrasive article of any one of embodiments 1 to 19, wherein the bond material comprises a tetragonal ZrO₂ (tZrO₂) in a content of at most 3.3 wt %, at most 3.2 wt %, at most 3 wt %, at most 2.9, at most 2.7 wt %, at most 2.5 wt %, at most 2.3 wt %, at most 2.1, at most 1.9 wt %, at most 1.8 wt %, or at most 1.6 wt % for a total weight of the bond material.

### Embodiment 21

The abrasive article of any one of embodiments 10 to 20, wherein monoclinic zirconia (mZrO₂) is present in the crystalline phase in a content of at least 0.1 wt % for a total weight of the crystalline phase, at least 0.5 wt %, at least 0.7 wt %, at least 1 wt %, at least 1.3 wt %, at least 1.5 wt %, at least 1.7 wt %, at least 1.8 wt %, at least 2.1 wt %, at least 2.5 wt %, at least 2.7 wt %, at least 2.9 wt %, at least 3.1 wt %, at least 3.3 wt %, at least 3.5 wt %, at least 3.7 wt %, at least 3.9 wt %, or at least 4 wt % for a total weight of the crystalline phase.

### Embodiment 22

The abrasive article of any one of embodiments 10 to 21, wherein monoclinic zirconia (mZrO₂) is present in the crystalline phase in a content of at most 73 wt % for a total weight of the crystalline phase, at most 69 wt %, at most at most 62 wt %, at most 58 wt %, at most 52 wt %, at most 47 wt %, at most at most 40 wt %, at most 35 wt %, at most 30 wt %, at most 25 wt %, at most 21 wt %, at most 16 wt %, at most 11 wt %, at most 8 wt %, at most 6, at most 4 wt %, at most 3.7 wt %, or at most 3.2 wt % for a total weight of the crystalline phase.

### Embodiment 23

The abrasive article of any one of embodiments 1 to 22, wherein the bond material comprises monoclinic zirconia (mZrO₂) in a content of at least 0.1 wt % for at total weight of the bond material, at least 0.3 wt %, at least 0.5 wt %, at least 9.8 wt %, at least 1 wt %, at least 1.3 wt %, at least 1.5 wt %, at least 1.7 wt %, at least 1.8 wt %, or at least 2 wt % for at total weight of the bond material.

### Embodiment 24

The abrasive article of any one of embodiments 1 to 23, wherein the bond material comprises monoclinic zirconian (mZrO₂) in a content of at most 3 wt % for at total weight of the bond material, at most 2.5, at most 2.2 wt %, at most 2 wt %, at most 1.8 wt %, at most 1.6, at most 1.5 wt %, at most 1.3 wt %, or at most 1.1 wt % for a total weight of the bond material.

### Embodiment 25

The abrasive article of any one of embodiments 10 to 24, wherein the crystalline phase comprises a ratio C_{ZOT}/C_{ZOM} of a content of tetragonal ZrO₂ (tZrO₂). C_{ZOT}, to a content of monoclinic ZrO₂ (mZrO₂), C_{ZOM}, wherein the content of tetragonal ZrO₂ (tZrO₂), C_{ZOT} is relative to a total crystalline phase content of the bond material, and the content of monoclinic ZrO₂ (mZrO₂) C_{ZOM} is relative to the total crystalline phase content of the bond material, wherein the ratio C_{ZOT}/C_{ZOM} is at least 0.003, at least 0.3, at least 0.7, at least 1, at least 1.1, at least 1.2, at least 1.4, at least 1.6, at least 1.8, at least 2, or at least 2.1.

### Embodiment 26

The abrasive article of any one of embodiments 10 to 25, wherein the ratio C_{ZOT}/C_{ZOM} is less than 2.1, at most 2, at most 1.8, at most 1.6, at most 1.4, at most 1.3, at most 1.2, or at most 1.

### Embodiment 27

The abrasive article of any one of embodiments 10 to 26, wherein the crystalline phase comprises lithium-aluminum-silicate, wherein lithium-aluminum-silicate comprises a solid solution of Li₂O—Al₂O₃-nSiO₂, wherein n includes 4, 6, 9, or any combination thereof, wherein lithium-aluminum-silicate comprises isoform 1 (LiAlSi₃O₈), isoform 2 (Li_{0.25}Al_{0.25}Si_{0.75}O₂), or a combination thereof.

### Embodiment 28

The abrasive article of any one of embodiments 1 to 27, wherein the bond material comprises lithium-aluminum-silicate isoform 1 (LiAlSi₃O₈) in a content of greater than 13 wt % for a total weight of the bond material, at least 14 wt %, at least 17 wt %, at least 20 wt %, at least 22 wt %, at least 25 wt %, at least 28 wt %, or at least 30 wt % for a total weight of the bond material.

### Embodiment 29

The abrasive article of any one of embodiments 1 to 28, wherein the bond material comprises lithium-aluminum-silicate isoform 1 (LiAlSi₃O₈) in a content of at most 45 wt % for a total weight of the bond material, such as at most 40 wt %, at most 38 wt %, at most 36 wt %, at most 32 wt %, at most 29 wt %, at most 27 wt %, at most 25 wt %, at most 22 wt %, at most 20 wt %, at most 16 wt %, or at most 14 wt % for a total weight of the bond material.

### Embodiment 30

The abrasive article of any one of embodiments 1 to 29, wherein LiAlSi₃O₈ is in a content of at least 30 wt % for a total weight of the crystalline phases, at least 35 wt %, at least 38 wt %, at least 42 wt %, at least 46 wt %, at least 50 wt %, at least 55 wt %, at least 60 wt %, at least 65 wt %, or at least 70 wt %, at least 73 wt %, at least 76 wt %, at least 80 wt %, or at least 82 wt % for a total content of the crystalline phases.

### Embodiment 31

The abrasive article of any one of embodiments 1 to 30, wherein LiAlSi₃O₈ is in a content of at most 90 wt % for a total weight of the crystalline phases of the bond material, at most 87 wt %, at most 84 wt %, at most 81 wt %, at most 77 wt %, at most 74 wt %, at most 71 wt %, at most 65 wt %, at most 60 wt %, at most 55 wt %, at most 50 wt %, at most 45 wt %, at most 41 wt %, or at most 35 wt % for the total weight of the crystalline phases of the bond material.

### Embodiment 32

The abrasive article of any one of embodiments 1 to 31, wherein the bond material comprises Li_{0.25}Al_{0.25}Si_{0.75}O₂ is in a content of at least 0.4 wt % for a total weight of the bond material, at least 1 wt %, at least 1.3 wt %, at least 1.5 wt %, at least 1.7 wt %, at least 1.8 wt %, at least 2 wt %, at least 2.3 wt %, at least 2.5 wt %, at least 2.7 wt %, at least 3 wt %, at least 3.2 wt %, at least 3.4 wt %, at least 3.6 wt %, at least 3.9 wt %, at least 4.4 wt %, at least 4.9 wt %, at least 5.1 wt %, at least 5.4 wt %, at least 6 wt %, at least 8 wt %, at least 11 wt %, at least 14 wt %, at least 17 wt %, or at least 20 wt % for a total weight of the bond material.

### Embodiment 33

The abrasive article of any one of embodiments 1 to 32, wherein the bond material comprises Li_{0.25}Al_{0.25}Si_{0.75}O₂ in a content of at most 20 wt % for the total weight of the bond material, at most 16 wt %, at most 13 wt %, at most 10 wt %, at most 7 wt %, at most 5.5 wt %, at most 5.1 wt %, at most 4.5 wt %, at most 3.5 wt %, at most 3 wt % at most 2 wt %, or at most 1.5 wt % for the total weight of the bond material.

### Embodiment 34

The abrasive article of any one of embodiments 10 to 33, wherein Li_{0.25}Al_{0.25}Si_{0.75}O₂ is present in a content of at least 1.2 wt % for the total weight of the crystalline phases of the bond material, at least 2 wt %, at least 3 wt %, at least 5 wt %, at least 8 wt %, at least 10 wt %, at least 13 wt %, at least 16 wt %, at least 19 wt %, at least 22 wt %, at least 25 wt %, at least 30 wt %, at least 35 wt %, at least 40 wt %, at least 45 wt %, or at least 50 wt % for a total weight of the crystalline phases of the bond material.

### Embodiment 35

The abrasive article of any one of embodiments 10 to 34, wherein Li_{0.25}Al_{0.25}Si_{0.75}O₂ is present in a content of at most 51 wt % for a total weight of crystalline phases of the bond material, at most 47 wt %, at most 42 wt %, at most 39 at %, at most 34 wt %, at most 31 wt %, at most 28 wt %, at most 24 wt %, at most 21 wt %, at most 18 wt %, at most 15 wt %, at most 12 wt %, at most 10 wt %, at most 8 wt %, at most 5 wt %, or at most 2 wt % for a total weight of the crystalline phases of the bond material.

### Embodiment 36

The abrasive article of any one of embodiments 10 to 35, wherein the crystalline phase comprises a ratio CSI1/CSI2 of a first content of LiAlSi₃O₈, CSI1, to a second content of a Li_{0.25}Al_{0.25}Si_{0.75}O₂, CSI2, wherein the first content of LiAlSi₃O₈, CSI1, is relative to the total crystalline phase content of the bond material, and the second content of Li_{0.25}Al_{0.25}Si_{0.75}O₂, CSI2, is relative to the total crystalline phase content of bond material, wherein the ratio CSI1/CSI2 is greater than 0.65, at least 0.8, at least 1, at least 1.2, at least 1.5, at least 2, at least 2.5, at least 3, at least 3.5, at least 4, at least 4.5, at least 5, at least 5.5, at least 7, at least 9, at least 12, at least 15, at least 20, at least 30, at least 40, at least 50, at least 60, or at least 70.

### Embodiment 37

The abrasive article of embodiment 36, wherein the ratio CSI1/CSI2 is at most 90, at most 85, at most 80, at most 75, at most 70, at most 65, at most 60, at most 55, at most 50, at most 45, at most 40, at most 35, at most 30, at most 20, at most 15, at most 10, at most 8, at most 5, or at most 3.

### Embodiment 38

The abrasive article of any one of embodiments 1 to 37, wherein the bond material comprises a total content of crystalline phases of at least 20 wt %, at least 26 wt %, at least 30 wt %, at least 33 wt %, at least 35 wt %, or at least 38 wt % for a total weight of the crystalline phases the bond material.

### Embodiment 39

The abrasive article of any one of embodiments 1 to 38, wherein the bond material comprises a total content of crystalline phases of less than 50 wt %, at most 40 wt %, at most 39 wt %, or at most 38 wt % for a total weight of the bond material.

### Embodiment 40

The abrasive article of any one of embodiments 1 to 39, wherein the bond material comprises one or more oxide including silica (SiO₂), alumina (Al₂O₃), boron oxide (B₂O₃), one or more alkali oxide including potassium oxide (K₂O), lithium oxide (Li₂O), sodium oxide (Na₂O), or any combination thereof, alkaline earth oxide including magnesium oxide (MgO), barium oxide (BaO), calcium oxide (CaO), or any combination thereof, zirconium oxide (ZrO₂), or any combination thereof.

### Embodiment 41

The abrasive article of any one of embodiments 1 to 40, wherein the bond material is essentially free of mullite (Al₂(Al_{2.8}Si_{1.2})O_{9.6}), mullite (Al₆Si₂O₁₃), anorthite (Na_{0.4}Ca_{0.6}Al_{1.6}Si_{2.4}O₈), quartz (SiO₂), crystalline LiAlSi₂O₆ or any combination thereof.

### Embodiment 42

The abrasive article of any one of embodiments 1 to 41, wherein the body comprises a permeability of at least 15 Darcy, at least 30 Darcy, at least 35 Darcy, at least 40 Darcy, at least 45 Darcy, at least 50 Darcy, or at least 55 Darcy.

### Embodiment 43

The abrasive article of any one of embodiments 1 to 42, wherein the body comprises a permeability of at most 70 Darcy, at most 67 Darcy, at most 62 Darcy, at most 60 Darcy, at most 58 Darcy, at most 55 Darcy, at most 52 Darcy, or at most 50 Darcy.

### Embodiment 44

The abrasive article of any one of embodiments 1 to 43, wherein the body comprises a porosity of at least 35 vol % for a total volume of the body, at least 43 vol %, at least 45 vol %, at least 47 vol %, at least 50 vol %, at least 53 vol %, at least 55 vol %, at least 57 vol %, at least 59 vol %, or at least 61 vol % for a total volume of the body.

### Embodiment 45

The abrasive article of any one of embodiments 1 to 44, wherein the body comprises a porosity of at 70 vol % for a total volume of the body, at most 67 vol %, at most 65 vol %, at most 62 vol %, at most 60 vol %, at most 58 vol %, at most 55 vol %, or at most 53 vol % for a total volume of the body.

### Embodiment 46

The abrasive article of any one of embodiments 1 to 45, wherein the body comprises at most 24 vol % of the bond material for a total volume of the body, at most 22 vol %, at most 20 vol %, at most 18 vol %, at most 16 vol %, at most 14 vol %, at most 12 vol %, at most 10 vol %, at most 8 vol %, at most 6 vol %, at most 4 vol %, or at most 3 vol % for a total volume of the body.

### Embodiment 47

The abrasive article of any one of embodiments 1 to 46, wherein the body comprises at least 1 vol %, of the bond material for a total volume of the body, at least 3 vol %, at least 5 vol %, at least 6.5 vol %, at least 8 vol %, at least 9.5 vol %, at least 12 vol %, at least 14 vol %, at least 16 vol %, or at least 18 vol % for a total volume of the body.

### Embodiment 48

The abrasive article of any one of embodiments 1 to 47, wherein the body comprises at least 30 vol % of abrasive agglomerates for a total volume of the body, at least 33 vol %, at least 35 vol %, at least 36 vol %, at least 38 vol %, at least 40 vol %, or at least 42 vol % for a total volume of the body.

### Embodiment 49

The abrasive article of any one of embodiments 1 to 48, wherein the body comprises at most 63 vol % of abrasive agglomerates for a total volume of the body, at most 60 vol %, at most 57 vol %, at most 52 vol %, at most 48 vol %, at most 45 vol %, at most 42 vol %, at most 40 vol %, or at most 38 vol % for a total volume of the body.

### Embodiment 50

The abrasive article of any one of embodiments 1 to 49, wherein the bond material comprises a coefficient of thermal expansion (CTE) of less than 7.8 ppm/° C. such as at most 7.5 ppm/° C., at most 7.2 ppm/° C., at most 7 ppm/° C., at most 6.7 ppm/° C., at most 6.4 ppm/° C., at most 6.1 ppm/° C., at most 5 ppm/° C., at most 4.5 ppm/° C., at most 4.1 ppm/° C. at most 3.8 ppm/° C., at least 3.4 ppm/° C., at most 3.2 ppm/° C., at most 3 ppm/° C., or at most 2.8 ppm/° C.

### Embodiment 51

The abrasive article of any one of embodiments 1 to 50, wherein the bond material comprises a coefficient of thermal expansion (CTE) of at least 1 ppm/° C., at least 1.4 ppm/° C., at least 1.6 ppm/° C., at least 1.8 ppm/° C., at least 2.1 ppm/° C., at least 2.4 ppm/° C., at least 2.6 ppm/° C., at least 2.8 ppm/° C., at least 3.0 ppm/° C., or at least 3.2 ppm/° C.

### Embodiment 52

The abrasive article of any one of embodiments 1 to 51, wherein the body comprises a Modulus of Rupture of at least 14 MPa, at least 15 MPa, at least 17 MPa, at least 18 MPa, at least 19 MPa, at least 20 MPa, or at least 21 MPa for a permeability of at least 15 Darcy.

### Embodiment 53

The abrasive article of any one of embodiments 1 to 52, wherein the body comprises a Modulus of Rupture of at most 30 MPa, at most 27 MPa, at most 25 MPa, at most 22 MPa, at most 20 MPa, or at most 18 MPa for a permeability of at least 15 Darcy.

### Embodiment 54

The abrasive article of any one of embodiments 1 to 53, wherein the body comprises a ratio of MOR/Peam of at most 1.5, at most 1.3, at most 1.1, at most 1, at most 0.8, at most 0.6, at most 0.5, or at most 0.3, wherein MOR represents a Modulus of Rupture of the body, and Peam represents permeability of the body, wherein the permeability is at least 15 Darcy.

### Embodiment 55

The abrasive article of any one of embodiments 1 to 54, wherein the body comprises a ratio of MOR/Peam of at least 0.05, at least 0.07, at least 0.09, at least 0.1, at least 0.12, at least 0.15, at least 0.18, at least 0.2, at least 0.22, at least 0.24, at least 0.26, at least 0.28, at least 0.3, or at least 0.5, wherein MOR represents a Modulus of Rupture of the body, and Peam represents permeability of the body, wherein the permeability is at least 15 Darcy.

### Embodiment 56

The abrasive article of any one of embodiments 1 to 55, wherein the body comprises a Modulus of Elasticity of at least 6 GPa, at least 8 GPa, at least 10 GPa, at least 12 GPa, or at least 15 GPa, wherein the permeability is at least 15 Darcy.

### Embodiment 57

The abrasive article of any one of embodiments 1 to 56, wherein the body comprises a Modulus of Elasticity of at most 65 GPa, at most 28 GPa, at most 25 GPa, at most 23 GPa, at most 21 GPa, or at most 18 GPa, wherein the permeability is at least 15 Darcy.

### Embodiment 58

The abrasive article of any one of embodiments 1 to 57, wherein the body comprises a ratio of MOE/Peam of at most 5, at most 1.3, at most 1.1, at most 1, at most 0.8, at most 0.6, at most 0.5, or at most 0.3, wherein MOE represents a Modulus of Elasticity of the body, and Peam represents permeability of the body, wherein the permeability is at least 15 Darcy.

### Embodiment 59

The abrasive article of any one of embodiments 1 to 58, wherein the body comprises a ratio of MOE/Peam of at least 0.05, at least 0.08, at least 0.1, at least 0.12, at least 0.15, at least 0.18, at least 0.2, at least 0.22, at least 0.24, at least 0.26, at least 0.28, or at least 0.3, wherein MOE represents a Modulus of Elasticity of the body, and Peam represents permeability of the body, wherein the permeability is at least 15 Darcy.

### Embodiment 60

The abrasive article of any one of embodiments 1 to 59, wherein the body comprises a Rockwell hardness (HRR or HRL) of at least 40, at least 43, at least 45, at least 50, at least 55, at least 58, at least 60, at least 62, at least 66, at least 70, at least 72, at least 75, at least 76, at least 80, at least 85, at least 88, at least 90, or at least 92 for a permeability of at least 15 Darcy.

### Embodiment 61

The abrasive article of any one of embodiments 1 to 60, wherein the body comprises a Rockwell hardness of at most 120, at most 110, at most 100, at most 97, at most 95, at most 92, at most 88, at most 84, at most 80, at most 78, at most 76, at most 73, at most 71, at most 68, at most 65, at most 62, at most 60, at most 58, at most 55, at most 53, at most 50, at most 47, or at most 45.

### Embodiment 62

The abrasive article of any one of embodiments 1 to 61, wherein the body comprises a ratio of RH/Peam of at most 9, at most 4.2, at most 3.9, at most 3.6, at most 3.2, at most 2.8, at most 2.5, at most 2.2, at most 2, at most 1.7, at most 1.5, at most 1.3, at most 1.1, at most 0.9, or at most 0.8, wherein RH represents a Rockwell hardness of the body, and Peam represents permeability of the body, wherein the permeability is at least 15 Darcy.

### Embodiment 63

The abrasive article of any one of embodiments 1 to 62, wherein the body comprises a ratio of RH/Peam of at least 0.3, at least 0.5, at least 0.8, at least 1, at least 1.2, at least 1.5, at least 1.8, at least 2, or at least 2.2, wherein HR represents a Rockwell hardness of the body, and Peam represents permeability of the body, wherein the permeability is at least 15 Darcy.

### Embodiment 64

An abrasive agglomerate, comprising:
abrasive particles comprising cubic boron nitride bonded by a binder material,
wherein the binder material comprises at least one of the following:
a content of zircon of greater than 0.5 wt % and less than 7.25 wt % for a total weight of the bond material;
a ratio of a content of ZrO₂ tetragonal phase C_{ZOT} to a content of a ZrO₂ monoclinic phase, C_{ZOM}, of at least 0.03 and at most 2.4, wherein the content of ZrO₂ tetragonal phase C_{ZOT} is relative to a total crystalline phase content of the binder material, and the content of ZrO₂ monoclinic phase C_{ZOM} is relative to a total crystalline phase content of binder material;
a ratio of a content of a first Li₂O—Al₂O₃-nSiO₂ phase, CSI1, to a content of a second Li₂O—Al₂O₃-nSiO₂ phase, CSI2, of at least 0.8 and at most 84, wherein the content of the first Li₂O—Al₂O₃-nSiO₂ phase, CSI1, is relative to the total content of the crystalline phase of the binder material, and the content of the second Li₂O—Al₂O₃-nSiO₂ phase, CSI2, is relative to the total content crystalline phase of binder material; or
any combination thereof.

### Embodiment 65

The abrasive agglomerates of any one of embodiments 1 to 64, wherein the abrasive agglomerates comprises a binder material comprising a vitrified material.

### Embodiment 66

The abrasive agglomerates of embodiment 65, wherein the abrasive agglomerates comprises at least 1 wt % of the binder for a total weight of the agglomerates, at least 2 wt %, at least 3 wt %, at least 5 wt %, at least 7 wt %, at least 9 wt %, at least 10 wt %, or at least 12 wt % for a total weight of the abrasive agglomerates.

### Embodiment 67

The abrasive agglomerates of embodiment 65 or 66, wherein the abrasive agglomerates comprises at most 20 wt % of the binder for a total weight of the agglomerates, at most 18 wt %, at most 16 wt %, at most 14 wt %, at most 12 wt %, at most 10 wt %, at most 8 wt %, or at most 6 wt % for a total weight of the abrasive agglomerates.

### Embodiment 68

The abrasive agglomerates of any one of embodiments 1 to 67, comprising greater than 50 wt % of abrasive particles for a total weight of the abrasive agglomerates, at least 52 wt %, at least 56 wt %, at least 59 wt %, at least 62 wt %, at least 65 wt %, at least 68 wt %, at least 70 wt %, at least 73 wt %, at least 77 wt %, at least 80 wt %, at least 83 wt %, at least 86 wt %, at least 88 wt %, at least 90 wt %, at least 92 wt %, or at least 95 wt % for a total weight of the abrasive agglomerates.

### Embodiment 69

The abrasive agglomerates of any one of embodiments 1 to 68, comprising at most 99 wt % of abrasive particles, at most 96 wt %, at most 93 wt %, at most 90 wt %, at most 87 wt %, at most 82 wt %, at most 78 wt %, at most 73 wt %, at most 70 wt %, at most 65 wt %, at most 62 wt %, at most 59 wt %, at most 56 wt %, or at most 53 wt % for at total weight of the abrasive agglomerates.

### Embodiment 70

The abrasive agglomerates of any one of embodiments 65 to 69, wherein the binder material comprises an amorphous phase, a crystalline phase, or any combination thereof.

### Embodiment 71

The abrasive agglomerates of any one of embodiments 65 to 70, wherein the binder material comprises a crystalline phase including one or more of an oxide, silicate, or any combination thereof.

### Embodiment 72

The abrasive agglomerates of any one of embodiments 65 to 71, wherein the binder material comprises a crystalline phase including zircon (ZrSiO₄), zirconia (ZrO₂), lithium-aluminum-silicate, or any combination thereof.

### Embodiment 73

The abrasive agglomerates of any one of embodiments 70 to 72, wherein zircon (ZrSiO₄) is present in the crystalline phase in a content of greater than 1 wt % for a total weight of the crystalline phase, at least 1.3 wt %, at least 1.5 wt %, at least 1.8 wt %, at least 2.1 wt %, at least 2.3 wt %, at least 2.5 wt %, at least 2.9 wt %, at least 3.3 wt %, at least 3.5 wt %, at least 3.8 wt %, at least 4.1 wt %, at least 4.3 wt %, at least 4.5 wt %, at least 4.9 wt %, at least 5.3 wt %, at least 5.5 wt %, at least 5.8 wt %, at least 6.1 wt %, at least 6.3 wt %, at least 6.5 wt %, at least 6.8 wt %, or at least 7.2 wt % for a total weight of the crystalline phase.

### Embodiment 74

The abrasive agglomerates of embodiment 72 or 73, wherein zircon (ZrSiO₄) is present in the crystalline phase in a content of less than 21 wt %, at most 20 wt %, at most 18 wt %, at most 16 wt %, at most 14 wt %, at most 12 wt %, at most 10.5 wt %, at most 9.5 wt %, at most 8 wt %, at most 6.5 wt %, or at most 5.8 wt % for a total weight of the crystalline phase.

### Embodiment 75

The abrasive agglomerates of any one of embodiments 65 to 74, wherein the binder material comprises a crystalline phase including tetragonal zirconian (tZrO₂), monoclinic zirconium (mZrO₂), or any combination thereof.

### Embodiment 76

The abrasive agglomerates of any one of embodiments 70 to 75, wherein tetragonal zirconia (tZrO₂) is present in the crystalline phase in a content of at least 0.3 wt % for a total weight of the crystalline phase, at least 0.5 wt %, at least 0.7 wt %, at least 1 wt %, at least 1.3 wt %, at least 1.5 wt %, at least 1.7 wt %, at least 1.8 wt %, at least 2.1 wt %, at least 2.5 wt %, at least 2.8 wt %, at least 3.2 wt %, at least 3.5 wt %, at least 3.8 wt %, at least 4.1 wt %, at least 4.3 wt %, at least 4.6 wt %, at least 4.8 wt %, or at least 5.1 wt % for a total weight of the crystalline phase.

### Embodiment 77

The abrasive agglomerates of any one of embodiments 70 to 76, wherein tetragonal zirconian (tZrO₂) is present in the crystalline phase in a content of at most 8.4 wt % for a total weight of the crystalline phase, at most 8.2 wt %, at most at most 8 wt %, at most 7.5 wt %, at most 7.2 wt %, at most 7 wt %, at most at most 6.8 wt %, at most 6.5 wt %, at most 6.2 wt %, at most 5.9 wt %, at most 5.7 wt %, at most 5.5 wt %, at most 5.2 wt %, at most 5 wt %, at most 4.9, at most 4.5 wt %, at most 4.2 wt %, or at most 4 wt % for a total weight of the crystalline phase.

### Embodiment 78

The abrasive agglomerates of any one of embodiments 65 to 77, wherein the binder material comprises a tetragonal ZrO₂ (tZrO₂) in a content of at least 0.1 wt % for a total weight of the binder material, at least 0.3 wt %, at least 0.5 wt %, at least 0.8 wt %, at least 1 wt %, at least 1.2 wt %, at least 1.3 wt %, at least 1.5 wt %, at least 1.6 wt %, at least 1.8 wt %, at least 2 wt %, at least 2.2 wt %, at least 2.5 wt %, at least 2.8 wt %, at least 3.1 wt %, or at least 3.3 wt % for a total weight of the binder material.

### Embodiment 79

The abrasive agglomerates of any one of embodiments 65 to 78, wherein the binder material comprises a tetragonal ZrO₂ (tZrO₂) in a content of at most 3.3 wt %, at most 3.2 wt %, at most 3 wt %, at most 2.9, at most 2.7 wt %, at most 2.5 wt %, at most 2.3 wt %, at most 2.1, at most 1.9 wt %, at most 1.8 wt %, or at most 1.6 wt % for a total weight of the binder material.

### Embodiment 80

The abrasive agglomerates of any one of embodiments 70 to 79, wherein monoclinic zirconia (mZrO₂) is present in the crystalline phase in a content of at least 0.1 wt % for a total weight of the crystalline phase, at least 0.5 wt %, at least 0.7 wt %, at least 1 wt %, at least 1.3 wt %, at least 1.5 wt %, at least 1.7 wt %, at least 1.8 wt %, at least 2.1 wt %, at least 2.5 wt %, at least 2.7 wt %, at least 2.9 wt %, at least 3.1 wt %, at least 3.3 wt %, at least 3.5 wt %, at least 3.7 wt %, at least 3.9 wt %, or at least 4 wt % for a total weight of the crystalline phase.

### Embodiment 81

The abrasive agglomerates of any one of embodiments 70 to 80, wherein monoclinic zirconia (mZrO₂) is present in the crystalline phase in a content of at most 73 wt % for a total weight of the crystalline phase, at most 69 wt %, at most at most 62 wt %, at most 58 wt %, at most 52 wt %, at most 47 wt %, at most at most 40 wt %, at most 35 wt %, at most 30 wt %, at most 25 wt %, at most 21 wt %, at most 16 wt %, at most 11 wt %, at most 8 wt %, at most 6, at most 4 wt %, at most 3.7 wt %, or at most 3.2 wt % for a total weight of the crystalline phase.

### Embodiment 82

The abrasive agglomerates of any one of embodiments 65 to 81, wherein the binder material comprises monoclinic zirconia (mZrO₂) in a content of at least 0.1 wt % for at total weight of the binder material, at least 0.3 wt %, at least 0.5 wt %, at least 9.8 wt %, at least 1 wt %, at least 1.3 wt %, at least 1.5 wt %, at least 1.7 wt %, at least 1.8 wt %, or at least 2 wt % for at total weight of the binder material.

### Embodiment 83

The abrasive agglomerates of any one of embodiments 65 to 82, wherein the binder material comprises monoclinic zirconia (mZrO₂) in a content of at most 3 wt % for at total weight of the binder material, at most 2.5 wt %, at most 2.2 wt %, at most 2 wt %, at most 1.8 wt %, at most 1.6, at most 1.5 wt %, at most 1.3 wt %, or at most 1.1 wt % for a total weight of the binder material.

### Embodiment 84

The abrasive agglomerates of any one of embodiments 70 to 83, wherein the crystalline phase comprises a ratio CZOT/CZOM of a content of tetragonal ZrO₂ (tZrO₂), C_{ZOT}, to a content of monoclinic mZrO₂ (m mZrO₂). C_{ZOM}, wherein the content of tetragonal ZrO₂ (tZrO₂), C_{ZOT}, is relative to a total crystalline phase content of the binder material, and the content of monoclinic_{zrO2} (mZrO₂) C_{ZOM} is relative to the total crystalline phase content of the binder material, wherein the ratio C_{ZOT}/C_{ZOM} is at least 0.003, at least 0.3, at least 0.7, at least 1, at least 1.1, at least 1.2, at least 1.4, at least 1.6, at least 1.8, at least 2, or at least 2.1.

### Embodiment 85

The abrasive agglomerates of any one of embodiments 70 to 84, wherein the ratio C_{ZOT}/C_{ZOM} is less than 2.1, at most 2, at most 1.8, at most 1.6, at most 1.4, at most 1.3, at most 1.2, or at most 1.

### Embodiment 86

The abrasive agglomerates of any one of embodiments 70 to 85, wherein the crystalline phase comprises lithium-aluminum-silicate, wherein lithium-aluminum-silicate comprises a solid solution of Li₂O—Al₂O₃-nSiO₂, wherein n includes 4, 6, 9, or any combination thereof, wherein lithium-aluminum-silicate comprises isoform 1 (LiAlSi₃O₈), isoform 2 (Li_{0.25}Al_{0.25}Si_{0.75}O₂), or a combination thereof.

### Embodiment 87

The abrasive agglomerates of any one of embodiments 65 to 86, wherein the binder material comprises LiAlSi₃O₈ in a content of greater than 13 wt % for a total weight of the binder material, at least 14 wt %, at least 17 wt %, at least 20 wt %, at least 22 wt %, at least 25 wt %, at least 28 wt %, or at least 30 wt % for a total weight of the binder material.

### Embodiment 88

The abrasive agglomerates of any one of embodiments 65 to 87, wherein the binder material comprises LiAlSi₃O₈ in a content of at most 45 wt % for a total weight of the binder material, such as at most 40 wt %, at most 38 wt %, at most 36 wt %, at most 32 wt %, at most 29 wt %, at most 27 wt %, at most 25 wt %, at most 22 wt %, at most 20 wt %, at most 16 wt %, or at most 14 wt % for a total weight of the binder material.

### Embodiment 89

The abrasive agglomerates of any one of embodiments 70 to 88, wherein LiAlSi₃O₈ in a content of at least 30 wt % for a total weight of the crystalline phase, at least 35 wt %, at least 38 wt %, at least 42 wt %, at least 46 wt %, at least 50 wt %, at least 55 wt %, at least 60 wt %, at least 65 wt %, or at least 70 wt %, at least 73 wt %, at least 76 wt %, at least 80 wt %, or at least 82 wt % for a total weight of the crystalline phase.

### Embodiment 90

The abrasive agglomerates of any one of embodiments 70 to 89, wherein LiAlSi₃O₈ in a content of at most 90 wt % for a total weight of the crystalline phase, at most 87 wt %, at most 84 wt %, at most 81 wt %, at most 77 wt %, at most 74 wt %, at most 71 wt %, at most 65 wt %, at most 60 wt %, at most 55 wt %, at most 50 wt %, at most 45 wt %, at most 41 wt %, or at most 35 wt % for the total weight of the bond material.

### Embodiment 91

The abrasive agglomerates of any one of embodiments 65 to 90, wherein the binder material comprises Li_{0.25}Al_{0.25}Si_{0.75}O₂ in a content of at least 0.4 wt % for a total weight of the binder material, at least 1 wt %, at least 1.3 wt %, at least 1.5 wt %, at least 1.7 wt %, at least 1.8 wt %, at least 2 wt %, at least 2.3 wt %, at least 2.5 wt %, at least 2.7 wt %, at least 3 wt %, at least 3.2 wt %, at least 3.4 wt %, at least 3.6 wt %, at least 3.9 wt %, at least 4.4 wt %, at least 4.9 wt %, at least 5.1 wt %, at least 5.4 wt %, at least 6 wt %, at least 8 wt %, at least 11 wt %, at least 14 wt %, at least 17 wt %, or at least 20 wt % for a total weight of the binder material.

### Embodiment 92

The abrasive agglomerates of any one of embodiments 65 to 91, wherein the binder material comprises Li_{0.25}Al_{0.25}Si_{0.75}O₂ in a content of at most 20 wt %, at most 16 wt %, at most 13 wt %, at most 10 wt %, at most 7 wt %, at most 5.5 wt %, at most 5.1 wt %, at most 4.5 wt %, at most 3.5 wt %, at most 3 wt % at most 2 wt %, or at most 1.5 wt % for the total weight of the binder material.

### Embodiment 93

The abrasive agglomerates of any one of embodiments 70 to 92, wherein Li_{0.25}Al_{0.25}Si_{0.75}O₂ is present in a content of at least 1.2 wt % for the total weight of the crystalline phase, at least 2 wt %, at least 3 wt %, at least 5 wt %, at least 8 wt %, at least 10 wt %, at least 13 wt %, at least 16 wt %, at least 19 wt %, at least 22 wt %, at least 25 wt %, at least 30 wt %, at least 35 wt %, at least 40 wt %, at least 45 wt %, or at least 50 wt % for a total weight of the crystalline phase.

### Embodiment 94

The abrasive agglomerates of any one of embodiments 70 to 93, wherein Li_{0.25}Al_{0.25}Si_{0.75}O₂ is present in a content of at most 51 wt % for a total weight of crystalline phase, at most 47 wt %, at most 42 wt %, at most 39 at %, at most 34 wt %, at most 31 wt %, at most 28 wt %, at most 24 wt %, at most 21 wt %, at most 18 wt %, at most 15 wt %, at most 12 wt %, at most 10 wt %, at most 8 wt %, at most 5 wt %, or at most 2 wt % for a total weight of the crystalline phase.

### Embodiment 95

The abrasive agglomerates of any one of embodiments 70 to 94, wherein the crystalline phase comprises a ratio CSI1/CS12 of a content of LiAlSi₃O₈, CSI1, to a second content of Li_{0.25}Al_{0.25}Si_{0.75}O₂, CSI2, wherein the content of LiAlSi₃O₈, CSI1, is relative to the total crystalline phase content of the binder material, and the second content of Li_{0.25}Al_{0.25} Si_{0.75}O₂, CSI2, is relative to a total crystalline phase content of binder material, wherein the ratio CSI1/CSI2 is greater than 0.65, at least 0.8, at least 1, at least 1.2, at least 1.5, at least 2, at least 2.5, at least 3, at least 3.5, at least 4, at least 4.5, at least 5, at least 5.5, at least 7, at least 9, at least 12, at least 15, at least 20, at least 30, at least 40, at least 50, at least 60, or at least 70.

### Embodiment 96

The abrasive agglomerates of embodiment 95, wherein the ratio CSI1/CSI2 is at most 90, at most 85, at most 80, at most 75, at most 70, at most 65, at most 60, at most 55, at most 50, at most 45, at most 40, at most 35, at most 30, at most 20, at most 15, at most 10, at most 8, at most 5, or at most 3.

### Embodiment 97

The abrasive agglomerates of any one of embodiments 65 to 96, wherein the binder material comprises a crystalline phase in a content of at least 20 wt %, at least 26 wt %, at least 30 wt %, at least 33 wt %, at least 35 wt %, or at least 38 wt % for a total weight of the binder material.

### Embodiment 98

The abrasive agglomerates of any one of embodiments 65 to 97, wherein the binder material comprises a crystalline phase in a content of less than 50 wt %, at most 40 wt %, at most 39 wt %, or at most 38 wt % for a total weight of the binder material.

### Embodiment 99

The abrasive agglomerates of any one of embodiments 65 to 98, wherein the binder material comprises one or more oxide including silica (SiO₂), alumina (Al₂O₃), boron oxide (B₂O₃), one or more alkali oxide including potassium oxide (K₂O), lithium oxide (Li₂O), sodium oxide (Na₂O), or any combination thereof, alkaline earth oxide including magnesium oxide (MgO), barium oxide (BaO), calcium oxide (CaO), or any combination thereof, zirconium oxide (ZrO₂), or any combination thereof.

### Embodiment 100

The abrasive agglomerates of any one of embodiments 65 to 99, wherein the binder material is essentially free of mullite (Al₂(Al_{2.8}Si_{1.2})O_{9.6} or Al₆Si₂O₁₃), anorthite (Na_{0.4}Ca_{0.6}Al_{1.6}Si_{2.4}O₈), quartz (SiO₂), crystalline LiAlSi₂O₆, or any combination thereof.

### EXAMPLES

The properties and advantage of the present disclosure are illustrated in further detail in the following nonlimiting examples. Unless otherwise indicated, temperatures are expressed in degrees Celsius, pressure is ambient, and concentrations are expressed in weight percentages.

### Example 1

Representative agglomerated cubic boron nitride particles were formed according to embodiments herein. Specifically, green agglomerates were formed by pushing the mixture including cubic boron nitride particles, dextran, and the binder composition through sieves having the pore sizes of 150-300 microns. Green agglomerates were heated at 550° C. for 4 hours in air to burn out the binder and then sintered at 995° C. for 4 hours in the N2 atmosphere to form the finally formed abrasive agglomerates. The agglomerated cubic boron nitride samples S1 and S2 included 3 wt % of the binder material and 10 wt % of the binder materials, respectively, for the total weight of the abrasive agglomerates. The phases of the binder material are included in Table 1 below. The agglomerates had the particle sizes of 150 to 300 microns.

TABLE 1

| Phases | Wt % |
|---|---|
| ZrSiO₄ | 2.15 |
| ZrO₂ (T) | 1.83 |
| ZrO₂ (M) | 1.50 |
| LiAlSi₃O₈ | 26.72 |
| Li_{0.25}Al_{0.25}Si_{0.75}O₂ | 5.46 |
| Silicate glass | 62.34 |

Abrasive wheel samples S3 and S4 were formed including the abrasive agglomerates S1 and S2, respectively, and a vitrified bond material. The composition of the precursor bond material for forming the bond material of sample S3 and S4 is included in Table 2.

TABLE 2

| Material | Weight % |
|---|---|
| K200 Feldspar | 23.06 |
| Spodumene | 22.22 |
| 5 mol Borax | 19.03 |
| Mullite | 16.04 |
| Kentucky #5 | 13.00 |
| ball clay | |
| Nyad 400 | 2.29 |
| wollastonite | |
| Al powder | 2.23 |
| Kentucky #6 | 2.13 |
| ball clay | |

Green bodies for wheel samples S3 and S4 were formed from the mixtures including the precursor bond material, agglomerates, and dextran, shaped, and sintered at 930° C. for 7 hours in air to form a finally-formed bonded abrasive bodies. Each wheel sample included 36 vol % of agglomerates, 6.41 vol % of the bond material, and 57.59 vol % of pores for the total volume of the bonded abrasive body. The composition of the finally-formed bond material is included in Table 3.

TABLE 3

| | S3 and S4 |
|---|---|
| | (wt %) |
| SiO₂ | 53.8 |
| Al₂O₃ | 18.9 |
| B₂O₃ | 12.3 |
| ZrO₂ | / |
| BaO | / |
| Li₂O | 2 |
| MgO | |
| K₂O | 3.25 |
| CaO | 1.8 |
| CoO | |
| Cr₂O₃ | |
| Fe₂O₃ | 0.45 |
| MnO₂ | |
| Na₂O | 6.8 |
| NiO | |
| SrO | |
| TiO₂ | 0.4 |
| Y₂O₃ | |
| P2O5 | 0.25 |
| ZnO | |
| Total | 100.0 |

Conventional wheel samples CS5 were formed using the mixture including the same precursor bond material as wheel samples S3 and S4, pore former, dextran, and unagglomerated cubic boron nitride having the D₅₀ of 151 microns and the same sintering conditions as those for forming wheel samples S3 and S4. Wheel samples CS5 included 32 vol % of cubic boron nitride, 28 vol % of the bond material, and 40 vol % of porosity for the total volume of the finally formed body.

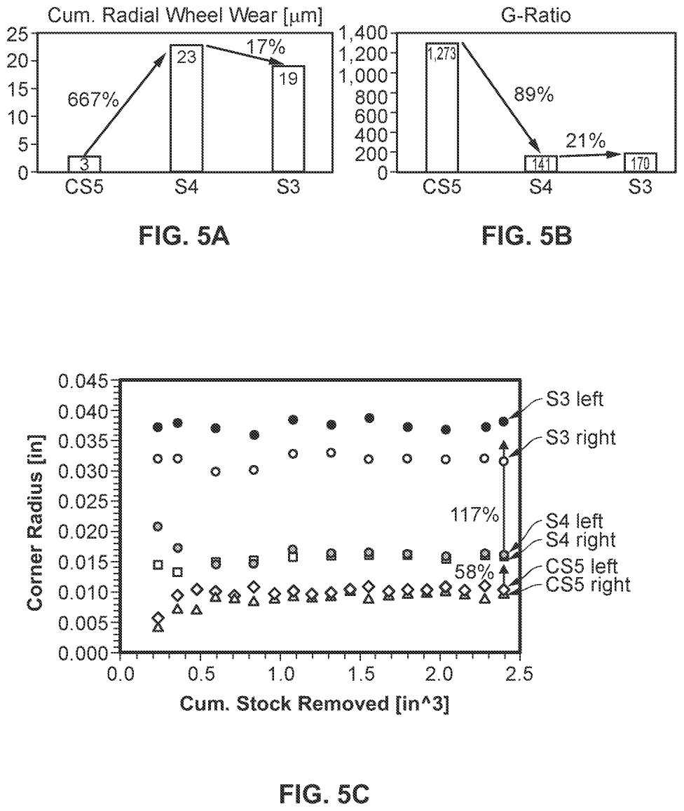

Wheel samples S3, S4, and CS5 were tested on creepfeed grinding of Inconel® 718 workpieces. As illustrated in FIG. 5A, wheel samples S3 and S4 demonstrated higher cumulative radial wheel wear (y-Axis); and as illustrated in FIG. 5B, wheel samples S3 and S4 demonstrated reduced G-ratio compared to wheel sample CS5. FIG. 5C includes a plot of corner radius vs. cumulative material removal. Wheel samples S3 and S4 generated larger corner radius and thus, rougher surface finish of the workpieces compared to wheel CS5.

### Example 2

Wheel samples S6 were formed including agglomerated cubic boron nitride particles and a vitrified bond material according to embodiments herein. The agglomerated cubic boron nitride particles were formed using the binder composition included in Table 1 in the same manner as described for samples S1 and S2. The agglomerates had the average particle size of 151 microns. The binder composition included in Table 1 was also used for forming the bond material. The mixture for forming the samples S6 included agglomerated cubic boron nitride particles, the precursor bond material, and dextran, was pressed to form a green body, which was then heated as follows to form finally formed bonded abrasive body.

The green body was heated at 650° C. for 1 hour in air to burn out the binder. Sintering was conducted in the atmosphere containing less than 100 ppm O₂ using the below heat schedule. Temperature was first increased from room temperature to 550° C. at 9° C./min and the soak time was 4 hours. The temperature was then increased to 995° C. at 2.5° C./min and the soak time was 1 hour. Cooling was then conducted. The temperature was decreased from 950° C. to 550° C. at −3.7° C./min and the soak time was 1 hour. The temperature was then decreased to 350 at −0.8° C./min and then to room temperature at −5.4° C./min.

The finally formed bonded abrasive body included 37 vol % of agglomerates, 13 vol % of the bond material, and 50 vol % of porosity for the total volume of the body. The finally formed bond material has the composition included in Table 4.

TABLE 4

| Phase | Wt % |
|---|---|
| ZrSiO₄ | 2.15 |
| ZrO₂ (T) | 1.83 |
| ZrO₂ (M) | 1.50 |
| LiAlSi₃O₈ | 26.72 |
| Li_{0.25}Al_{0.25}Si_{0.75}O₂ | 5.46 |
| Silicate glass | 62.34 |

Wheel samples CS5 and S6 had the same dimension, 12″OD×5″ID×0.5″ thick, and were tested on creepfeed grinding of Inconel®718 workpieces with the following testing conditions in Table 5 using Magerle machine.

TABLE 5

| Q′ | 0.3 | in³/min/in |
|---|---|---|
| Coolant | Water soluble | |
| Wheel speed | 2865 | rpm |
| Table speed | 3.33 | in/min |

| | |
|---|---|
| Grind path | 4″ in length |

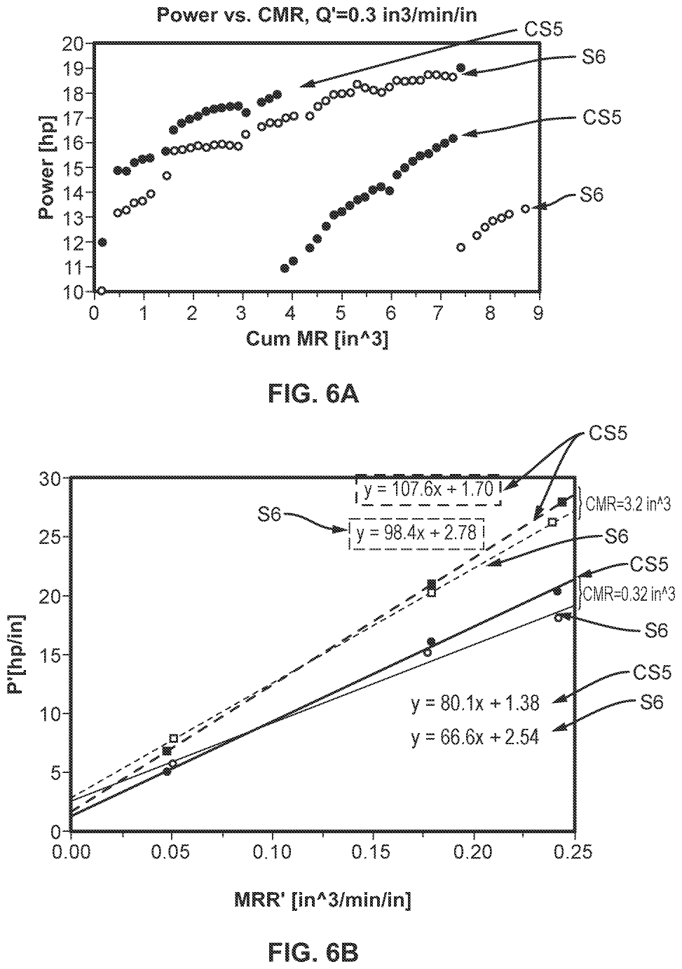

FIG. 6A includes a plot of power vs. cumulative material removal of wheel samples CS5 and S6. Samples S6 required lower power for the same amount of material removal compared to wheel samples CS5. Further notably, samples CS5 needed dressing when the cumulated removal was about 3.5 in³, while samples S6 was dressed when the removal was about 7.3 in³.

FIG. 6B includes a plot of specific power vs. Q′ of samples CS5 and S6. As illustrated, wheel samples S6 required less specific power for higher material removal rates compared to CS5 when the cumulative material removal (CMR) was set at 0.32 in³ and 3.2 in³. Specifically, it can be observed when the CMR was set at 0.32 in³ and the material removal rate was above approximately 0.125 in³/min/in, wheel samples S6 started to require less specific power compared to CS5; and when the CMR was set at 3.2 in³ and the material removal rate was above approximately 0.175 in³/min/in, wheel samples S6 started to require less specific power compared to CS5. The slopes represent specific grinding energy of the wheel samples. For the CMR set at 0.32 in³, the specific grinding energy of samples S6 and CS5 was approximately 66.6 and 80.1, respectively, which indicates the specific grinding energy of S6 was approximately 17% less than that of CS5. For the CMR set at 3.2 in³, the specific grinding energy of samples S6 and CS5 was approximately 98.4 and 107.6, respectively, which indicates the specific grinding energy of S6 was approximately 9% less than that of CS5. It should be further noted that lower specific grinding energy suggests better chip clearance of wheel samples S6 than CS5.

Powder X-ray diffraction analysis was performed on the bond materials of CS5 and S6.

The bond materials of CS5 had crystalline phases of corundum (Al₂O₃), mullite (Al₂(Al_{2.8}Si_{1.2})O_{9.6}), anorthite (Na_{0.4}Ca_{0.6}Al_{1.6}Si_{2.4}O₈), quartz (SiO₂), and LiAlSi₂O₆. The bond materials of CS5 is free of crystalline phases of zircon (ZrSiO₄), zirconia (ZrO₂), LiAlSi₃O₈ and Li_{0.25}Al_{0.25}Si_{0.75}O₂.

The bond material of S6 had crystalline phases of zircon (ZrSiO₄), tetragonal zirconia ((ZrO₂), monoclinic zirconia (mZrO₂), LiAlSi₃O₈ and Li_{0.25}Al_{0.25}Si_{0.75}O₂. The bond material of S6 is free of crystalline phases of corumdum (Al₂O₃), mullite (Al₂(Al_{2.8}Si_{1.2})O_{9.6}), anorthite (Na_{0.4}Ca_{0.6}Al_{1.6}Si_{2.4}O₈), and quartz (SiO₂). An SEM image of the bond material of wheel samples S6 is included in FIG. 4. Crystals of zircon, zirconia, and lithium-aluminum-silicate are demonstrated in the image.

### Example 3

Abrasive samples CS7 were formed having the same compositions as wheels CS5 and in the same manners as described for CS5. Abrasive samples S8 were formed having the same compositions as wheels S6 except the agglomerates had the average particle size of 126 microns, and in the same manners as described with respect to wheels S6. The samples were tested for 4-point bend flexure strength according to embodiments herein.

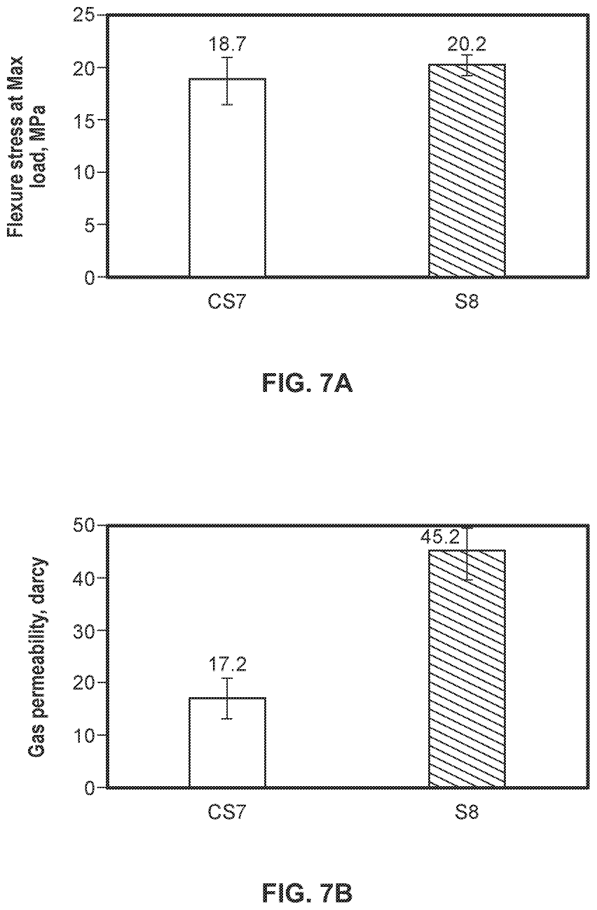

As illustrated in FIGS. 7A and 7B, the samples CS7 and S8 had similar flexure strength (FIG. 7A), while samples S8 had the average permeability of 45.2 Darcy and samples CS7 had the average permeability of 17.2 Darcy.

### Example 4

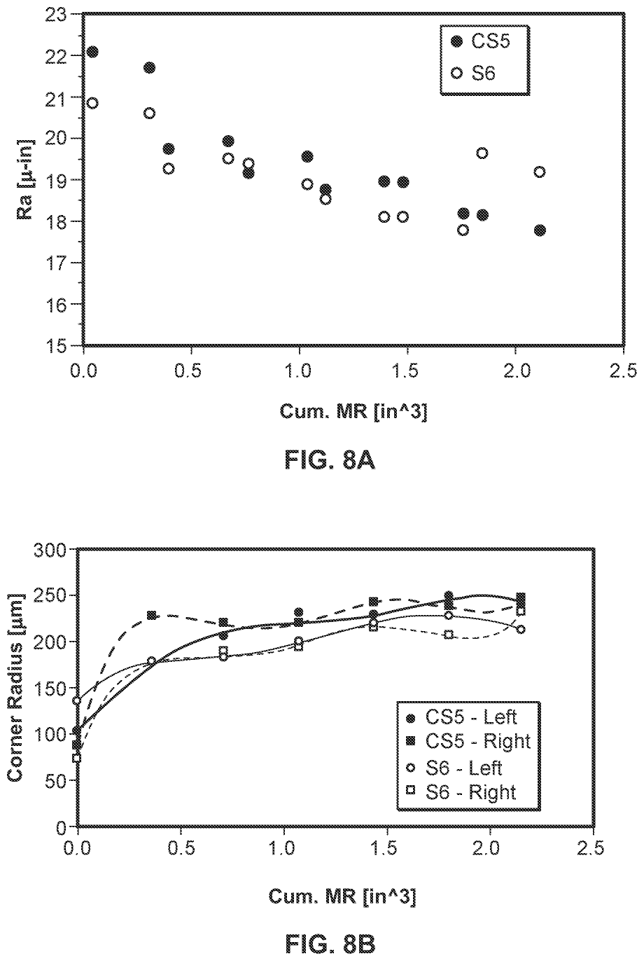

Wheel samples CS5 and S6 were tested on creepfeed grinding of Inconel®718 workpieces using the conditions in Table 5. FIG. 8A includes a plot of workpiece roughness Ra vs. cumulative material removal. It can be observed wheel samples CS5 and S6 performed similarly. FIG. 8B includes a plot of corner radius vs. cumulative material removal. As illustrated, at given cumulative material removal, wheel samples CS5 and S6 yielded similar corner radius.

### Example 5

Samples S9 to S12 were formed in the same manner as described for forming wheel samples S6, except for the sintering temperatures and soak times, which are included in Table 6. Samples S9 to S12 had the same composition as S6.

Table 6 includes the compositions of the bond materials of the samples determined using powder X-ray diffraction and reitveld analysis according to embodiments herein. It can be observed with the increase of the sintering temperatures and/or soak time, the contents of the crystalline phases including the noted oxides change. For example, sintering at 995° C. may facilitate formation of LiAlSi₃O₈. The contents of the amorphous phase also demonstrated some changes with changes to the sintering temperatures.

TABLE 6

| | S9 | S10 | S11 | S12 | S9 | S10 | S11 | S12 |
|---|---|---|---|---|---|---|---|---|
| | 950° C. | 995° C. | 995° C. | 1050° C. | 950° C. | 995° C. | 995° C. | 1050° C. |
| | 4 hrs soak | 4 hrs soak | 6 hr soak | 4 hrs soak | 4 hrs soak | 4 hrs soak | 6 hr soak, | 4 hrs soak |
| | Relative to the total weight | | | | Relative to the total weight | | | |
| | of the bond material (wt %) | | | | of the crystalline phase (wt %) | | | |
| ZrSiO₄ | 0.5 | 2.15 | 2.15 | 7.25 | 1.25 | 5.71 | 6.07 | 20.51 |
| ZrO₂ | 3.4 | 1.83 | 1.26 | 0.07 | 8.47 | 4.86 | 3.56 | 0.2 |
| (Tetragonal) | | | | | | | | |
| ZrO₂ | 1.61 | 1.5 | 0.98 | 0 | 4.01 | 3.98 | 2.77 | 75.7 |
| (Monoclinic) | | | | | | | | |
| LiAlSi₃O₈ | 13.68 | 26.72 | 30.63 | 26.76 | 34.08 | 70.95 | 86.45 | 3.59 |
| Li_{0.25}Al_{0.25}Si_{0.75}O₂ | 20.95 | 5.46 | 0.41 | 1.27 | 52.19 | 14.50 | 1.16 | / |
| Amorphous | 59.86 | 62.34 | 64.57 | 64.65 | / | / | / | / |
| Sum | 100.00 | 100.00 | 100.00 | 100.00 | 100.00 | 100 | 100.00 | 100.00 |

### Example 6

Additional abrasive samples were formed. Samples S16 were formed in the same manner as Sample S6 of Example 2. Samples S17 were formed in the same manner as Sample S3 of Example 1. Abrasive bodies of the samples were analyzed using X-ray diffraction. Average contents of some crystalline phases of the samples are noted in Table 7.

TABLE 7

| | S16 | | S17 | |
|---|---|---|---|---|
| | Relative to | Relative to | Relative to | Relative to |
| | the total | the total | the total | the total |
| | weight | weight | weight | weight |
| | content of | content of | content of | content of |
| | crystalline | the crystalline | crystalline | the crystalline |
| | phases of | phases of | phases of | phases of |
| Crystalline | the body | the bond | the body | the bond |
| phases | (wt %) | (wt %) | (wt %) | (wt %) |
| ZrSiO₄ | 1.2 | 18.5 | 0.1 | 3.1 |
| ZrO₂ | 0.1 | 1.55 | Not | / |
| (Monoclinic) | | | detected | |
| LiAlSi₃O₈ | 5.0 | 76.9 | Not | / |
| | | | detected | |
| FeO | 0.2 | 3.1 | 0.2 | 6.8 |
| Anorthite | Not | / | 0.75 | 25.8 |
| | detected | | | |
| Mullite | Not | / | 1.4 | 43.1 |
| (Al₆Si₂O₁₃) | detected | | | |
| Quartz | Not | / | 0.5 | 15.3 |
| (SiO₂) | detected | | | |
| LiAlSi₂O₆ | Not | / | 0.3 | 9.4 |
| | detected | | | |

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

1. An abrasive article, comprising a body comprising:
abrasive agglomerates bonded by a bond material,
wherein the abrasive agglomerates comprise abrasive particles including cubic boron nitride,
wherein the bond material comprises crystalline phases comprising at least one of:
ZrSiO₄ of at least 4.9 wt % and at most 20 wt % for a total weight of the crystalline phases;
monoclinic ZrO₂; or
LiAlSi₃O₈; and
wherein the bond material is essentially free of quartz, crystalline LiAlSi₂O₆ (Li₂O*Al₂O₃*nSiO₂n=4), anorthite, mullite (Al₆Si₂O₁₃ or Al₆Si₂O₁₃), or any combination thereof.

2. The abrasive article of claim 1, wherein the bond material comprises a coefficient of thermal expansion (CTE) of less than 7.8 ppm/° C. and at least 1 ppm/° C.

3. The abrasive article of claim 1, wherein the body comprises:
at least one of a porosity in a content of at least 40 vol % for a total volume of the body or a permeability of at least 15 Darcy; and
at least one of a Modulus of Rupture of at least 14 MPa, a Modulus of Elasticity of at least 6 GPa, a flexure strength of at least 14 MPa, a Rockwell hardness of at least 40, or a combination thereof.

4. The abrasive article of claim 1, wherein the bond material comprises a total content of the crystalline phases of at least 20 wt % and less than 50 wt % for a total weight of the bond material.

5. The abrasive article of claim 1, wherein the bond material comprises an amorphous phase.

6. The abrasive article of claim 5, wherein the amorphous phase is at least 55 wt % for a total weight of the bond material.

7. The abrasive article of claim 1, wherein the bond material comprises a crystalline phase including zircon (ZrSiO₄) in a content of at least 4.9 wt % and at most 20 wt % for the total weight of the crystalline phases of the bond material.

8. The abrasive article of claim 1, wherein the bond material comprises a crystalline phase including monoclinic zirconia (mZrO₂).

9. The abrasive article of claim 1, wherein the bond material comprises a crystalline phase including monoclinic zirconia (mZrO₂) in a content of at least 0.1 wt % and at most 25 wt % for the total weight of crystalline phases of the bond material.

10. The abrasive article of claim 1, wherein the bond material comprises a crystalline phase comprising LiAlSi₃O₈.

11. The abrasive article of claim 10, wherein the crystalline phase including LiAlSi₃O₈ is at least 30 wt % and at most 90 wt % for the total weight of crystalline phases of the bonded material.

12. The abrasive article of claim 11, wherein the bond material comprises the total weight of the crystalline phases of at most 40 wt % for a total weight of the bond material.

13. The abrasive article of claim 1, wherein the bond material comprises one or more oxide including silica (SiO₂), alumina (Al₂O₃), boron oxide (B₂O₃), one or more alkali oxide including potassium oxide (K₂O), lithium oxide (Li₂O), sodium oxide (Na₂O), or any combination thereof, alkaline earth oxide including magnesium oxide (MgO), barium oxide (BaO), calcium oxide (CaO), or any combination thereof, zirconium oxide (ZrO2), or any combination thereof.

14. The abrasive article of claim 1, wherein the bond material is essentially free of quartz (SiO₂).

15. The abrasive article of claim 1, wherein the body comprises for a total volume of the body, a porosity of at least 35 vol % and at most 70 vol %; the bond material of at least 1 vol % and at most 24 vol %; the abrasive agglomerates of at least 30 vol % and at most 60 vol %; and a permeability of at least 17 Darcy.

16. An abrasive article, comprising a body comprising:
a bond material comprising an inorganic material;
abrasive agglomerates bonded by the bond material;
a porosity in a content of at least 35 vol % for a total volume of the body;
one or more crystalline phases comprising ZrSiO₄ in a content of greater than 0.5 wt % and less than 7.5 wt % for a total weight of the bond material; and
an amorphous phase of at least 55 wt % and at most 75 wt % for the total weight of the bond material.

17. The abrasive article of claim 16, wherein the one or more crystalline phases comprises LiAlSi₃O₈.

18. The abrasive article of claim 17, wherein a content of LiAlSi₃O₈ is greater than 13 wt % and at most 45 wt % for the total weight of the bond material.

19. The abrasive article of claim 16, wherein the one or more crystalline phases comprises monoclinic zirconia (mZrO₂), wherein a content of monoclinic zirconia (mZrO₂) is at most 3 wt % for the total content of the bond material.

20. The abrasive article of claim 16, wherein the body comprises the bond material of at least 1 vol % and at most 24 vol % and the abrasive agglomerates of at least 30 vol % and at most 60 vol % for the total volume of the body.
